(19) United States
(12) Patent Application Publication
(10) Pub. No.: US 2008/0296520 A1
(43) Pub. Date: Dec. 4, 2008

(54) OPTICAL COUPLING DEVICE

(75) Inventor: Yoshio Noguchi, Fukuoka-ken (JP)

Correspondence Address: AMIN, TUROCY & CALVIN, LLP, 127 Public Square, 57th Floor, Key Tower, CLEVELAND, OH, 44114, US

(73) Assignee: KABUSHIKI KAISHA TOSHIBA, Tokyo (JP)

(21) Appl. No.: 11/865,823

(22) Filed: Oct. 2, 2007

(30) Foreign Application Priority Data
Oct. 3, 2006 (JP) 2006-271638

(51) Int. Cl. H04B 3/03

(52) U.S. Cl. 250/551

(57) ABSTRACT

In one aspect of the present invention, an optical coupling may include a supporting member which has a first surface, a second surface on the opposite side of the first surface, and an opening portion, and which is formed of an insulating material, a first wiring layer provided on the first surface of the supporting member, a second wiring layer provided on the second surface of the supporting member, a light emitting element which is provided on the first surface, and which is connected to the first wiring layer, and at least one portion of which faces the opening portion, a light receiving element which is provided on the second surface, and which is connected to the second wiring layer, and which faces the light emitting element through the opening portion, a light shielding resin provided so as to cover the light emitting element, the light receiving element, and the first wiring layer and the second wiring layer.

### CROSS REFERENCE TO RELATED APPLICATION

This application is based upon and claims the benefit of priority from Japanese Patent Application No. 2006-271638, filed on Oct. 3, 2006, the entire contents of which are incorporated herein by reference.

### BACKGROUND

A face-to-face structure is often used for an optical coupling device. In the face-to-face structure, a light emitting element such as a light emitting diode (LED), and a light receiving element formed of a silicon photodiode, a phototransistor and the like, are arranged on each of metal leads so as to face each other. The light emitting element and the light receiving element are primarily sealed by, for example, a translucent resin, and then the outer portions thereof and the leads are secondarily sealed by a light shielding resin.

### SUMMARY

In one aspect of the present invention, an optical 20 coupling may include a supporting member which has a first surface, a second surface on the opposite side of the first surface, and an opening portion, and which is formed of an insulating material, a first wiring layer provided on the first surface of the supporting member, a second wiring layer provided on the second surface of the supporting member, a light emitting element which is provided on the first surface, and which is connected to the first wiring layer, and at least one portion of which faces the opening portion, a light receiving element which is provided on the second surface, and which is connected to the second wiring layer, and which faces the light emitting element through the opening portion, alight shielding resin provided so as to cover the light emitting element, the light receiving element, and the first wiring layer and the second wiring layer.

In another aspect of the invention, an optical coupling may include a package having a supporting member which has a first surface, a second surface on the opposite side of the first surface, and an opening portion, and having a frame portion provided in a circumference of the supporting member, a first wiring layer provided on the first surface of the supporting member, a second wiring layer provided on the second surface of the supporting member, a light emitting element which is provided on the first surface, and which is connected to the first wiring layer, and at least one portion of which faces the opening portion, a light receiving element which is provided on the second surface, which is connected to the second wiring layer, and which faces the light emitting element through the opening portion, and a light shielding resin provided so as to cover the light emitting element, the light receiving element, the first wiring layer and the second wiring layer.

### BRIEF DESCRIPTIONS OF THE DRAWINGS

A more complete appreciation of the invention and many of the attendant advantages thereof will be readily obtained as the same becomes better understood by reference to the following detailed description when considered in connection with the accompanying drawings.

FIG. 1 is a cross sectional view of a optical coupling in accordance with a first embodiment of the present invention.

FIGS. 2A to 2O are schematic views showing production processes of the present embodiment.

FIG. 3A is a schematic plan view of the connected supporting members 20 in the state of FIGS. 2C and 2D in the manufacturing multiple-chip processing. FIGS. 3B and 3C are enlarged schematic plan view of the connected supporting member 20 shown in FIG. 3A.

FIG. 4A is a schematic plan view. FIG. 4B is a schematic cross-sectional view. FIG. 4C is a schematic bottom view. FIG. 4D is a schematic perspective view.

FIG. 5A is a schematic plan view. FIG. 5B is a schematic cross-sectional view. FIG. 5C is a schematic bottom view. FIG. 5D is a schematic perspective view.

FIG. 5E is an equivalent circuit view.

FIGS. 6A to 6Q are schematic views showing production processes of the present embodiment.

FIG. 7A is a schematic plan view. FIG. 7B is a schematic cross-sectional view. FIG. 7C is a schematic bottom view. FIG. 7D is a schematic perspective view.

FIGS. 8A to 8Q are schematic views showing processes of manufacturing the present modification.

### DETAILED DESCRIPTION

Various connections between elements are hereinafter described. It is noted that these connections are illustrated in general and, unless specified otherwise, may be direct or indirect and that this specification is not intended to be limiting in this respect.

Embodiments of the present invention will be explained with reference to the drawings as next described, wherein like reference numerals designate identical or corresponding parts throughout the several views.

### FIRST EMBODIMENT

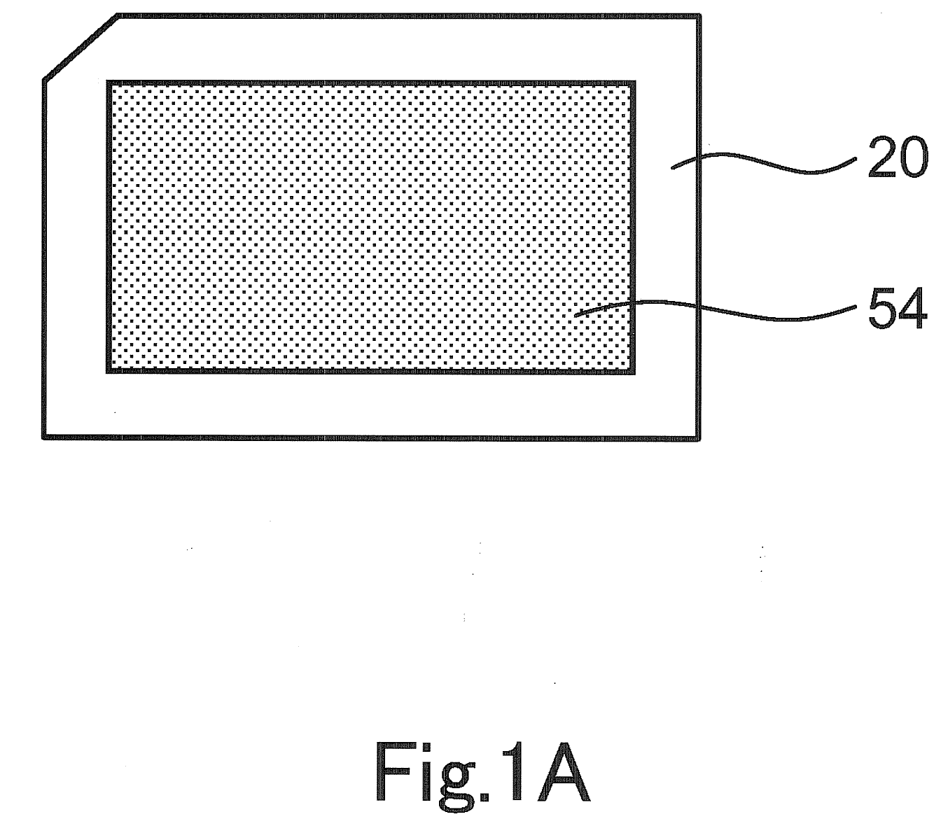

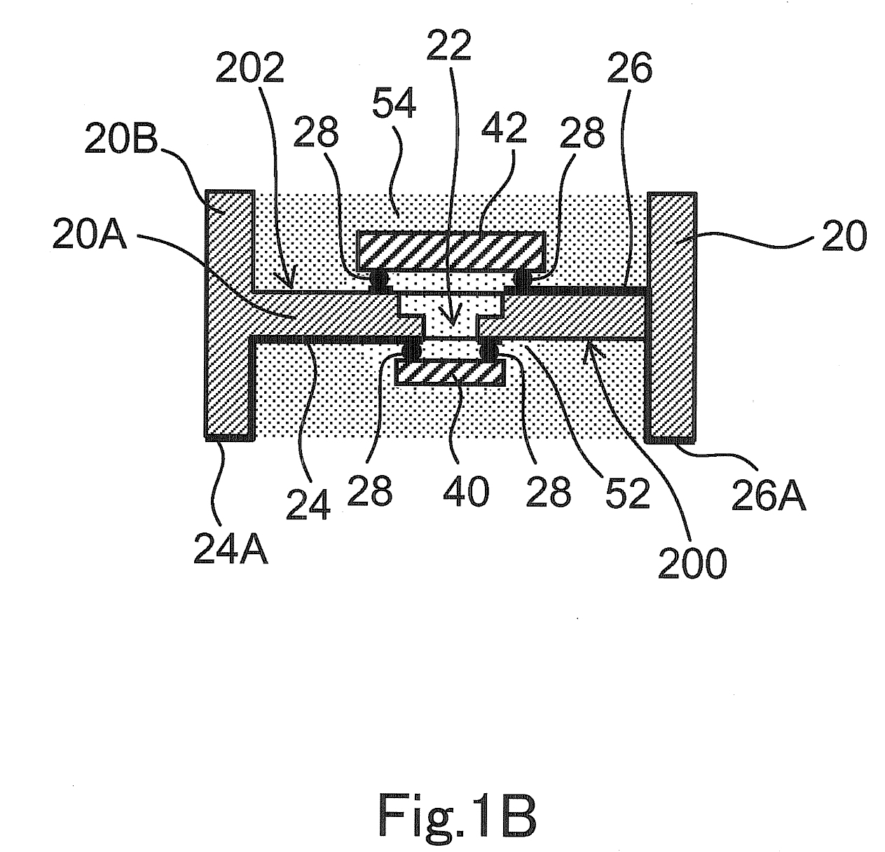

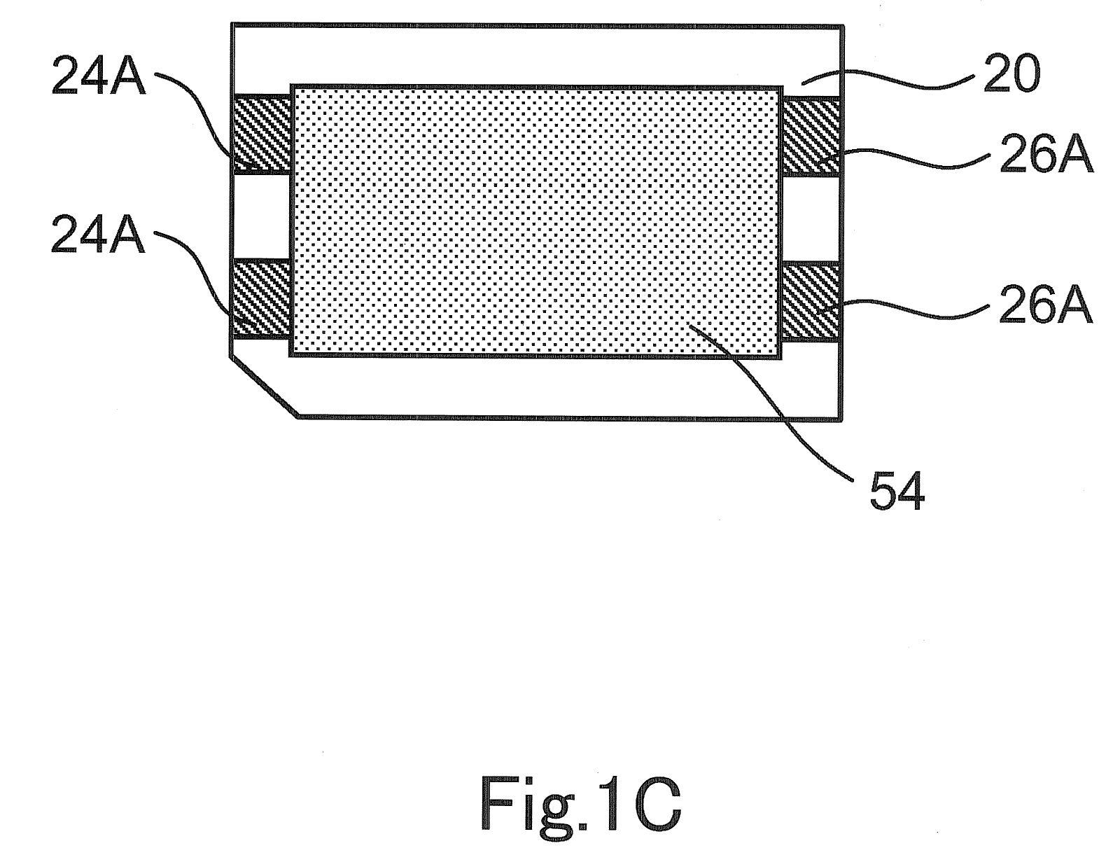

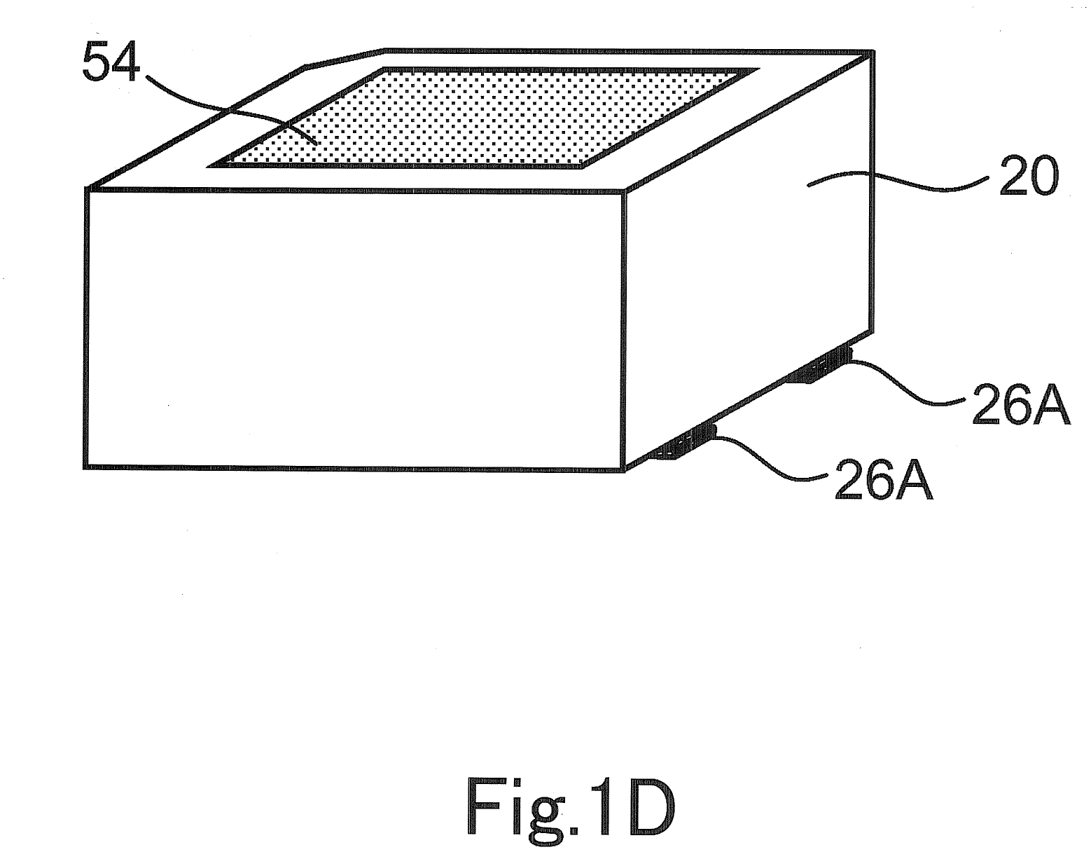

FIGS. 1A to 1D show an optical coupling device according to a first embodiment of the present invention. FIG. 1A is a schematic plan view. FIG. 1B is a schematic cross-sectional view. FIG. 1C is a schematic bottom view.

FIG. 1D is a schematic perspective view.

A supporting member 20, which is formed of an insulating substrate or an insulating compact, is provided with an opening portion 22. As for a material of the insulating substrate, ceramic, glass epoxy or the like can be used. As for a material of the insulating compact, a resin or the like can be used.

The supporting member 20 has a supporting portion 20A having a first surface 200 and a second surface 202 and a frame portion 20B which is set up so as to surround a circumference thereof. The opening portion 22 is provided in the supporting portion 20A. Wiring layers 24 and 26 are respectively formed on the first and second surfaces 200 and 202 of the supporting portion 20A. These wiring layers 24 and 26 extend to the frame portion 20B to be exposed as terminals 24A and 26A. Then, as shown in FIG. 1B, under the opening portion 22, a light emitting element 40 such as an LED is connected with the wiring layer 24 by using bumps 28. The light emitting element 40 is provided in such a manner that at least one portion thereof faces with the opening portion 22, and light the opening portion 22. A wavelength of the light emitted from the light emitting element 40 is, for example, in a range from visible light to infrared light.

A light receiving element 42 receives emitted light or reflected light having passed through the opening portion 22, and is connected with the wiring layer 26 by bumps 28. As for the light receiving element 42, a photodiode, a phototransistor, or the like is used. As a material of the light receiving element 42, there is used a silicon with high light receiving sensitivity in a range of wavelength from visible light to infrared light. In an optical path between the light emitting element 40 and the light receiving element 42, a translucent resin 52 such as a silicone is provided. Furthermore, a light shielding resin 54 such as epoxy is provided so as to cover the light emitting element 40, the light receiving element 42, the translucent resin 52, and the like. The above-mentioned structure is referred to as “face-to-face type” structure.

When an input signal is added to a light emitting element terminal 24A to light the light emitting element 40, the 5 emitted light enters the light receiving element 42 through the translucent resin 52 being the optical path, so that the light receiving element 42 becomes conductive.

On the other hand, when the light emitting element 40 10 is put off, the light receiving element 42 becomes nonconductive. In this manner, the light receiving element 42 is switched between the conductive state and the nonconductive state, and a signal from the light receiving element terminal 26A, which is to be an output terminal, is to be switched between an on-state and an off-state. As a result, a signal can be transmitted/received in a state where a power system is insulated.

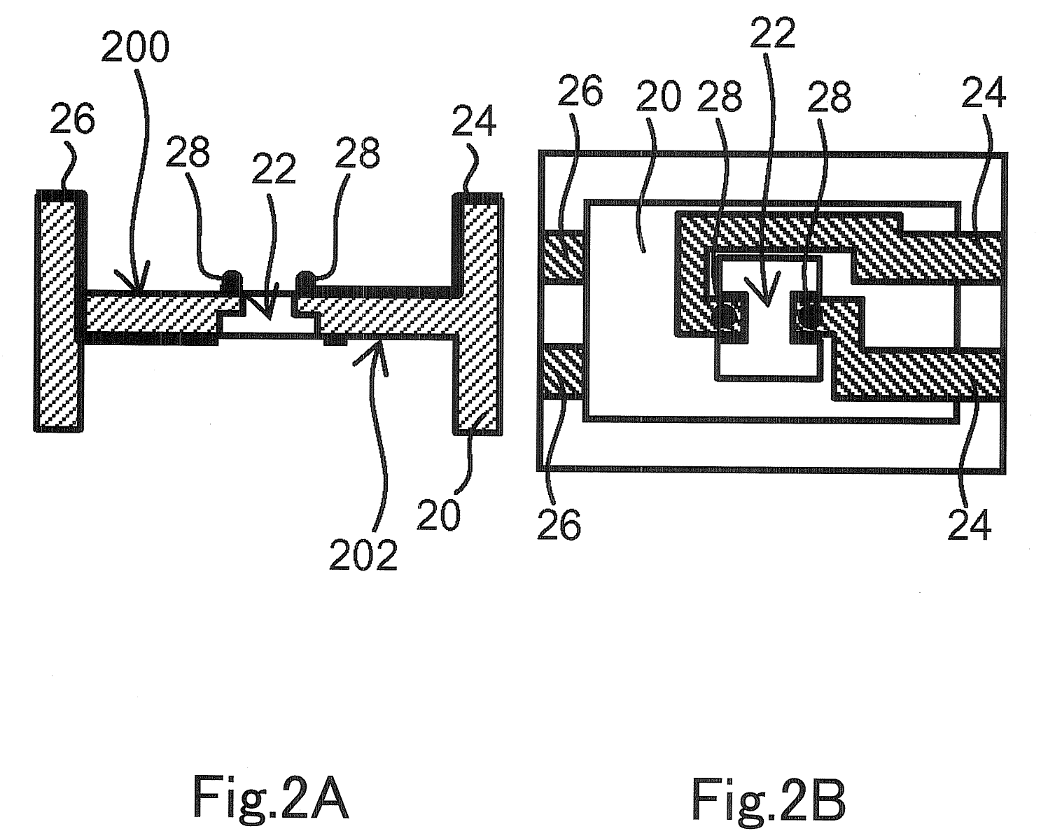

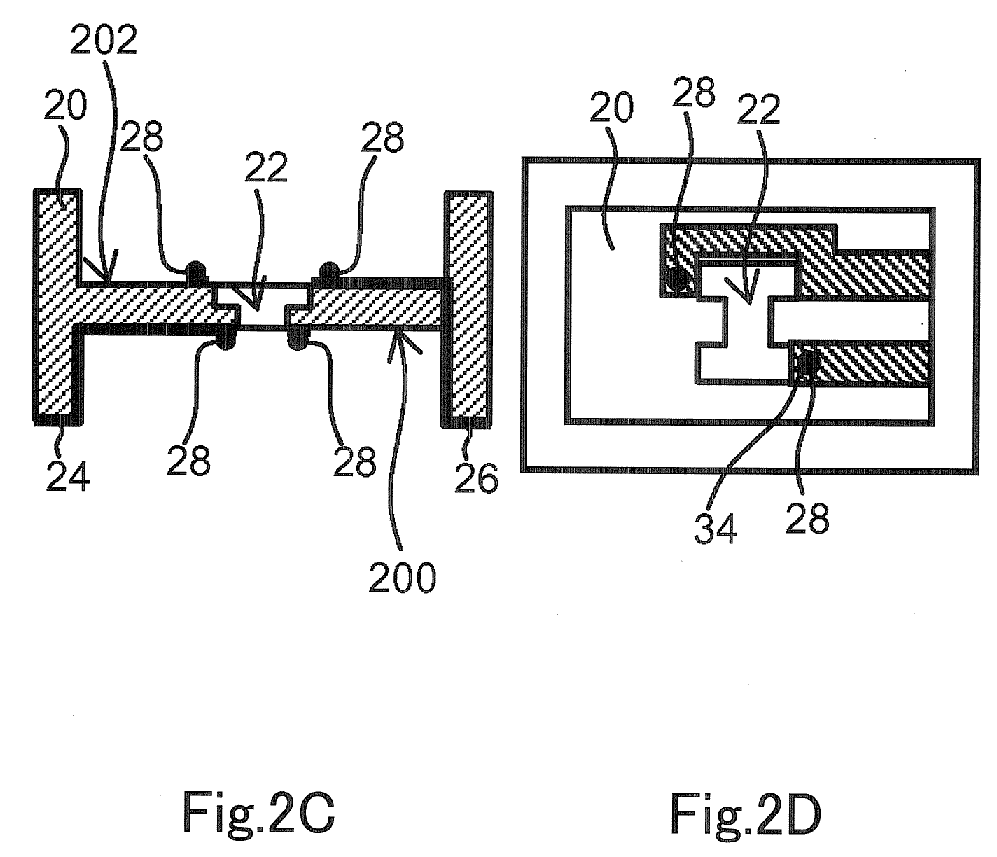

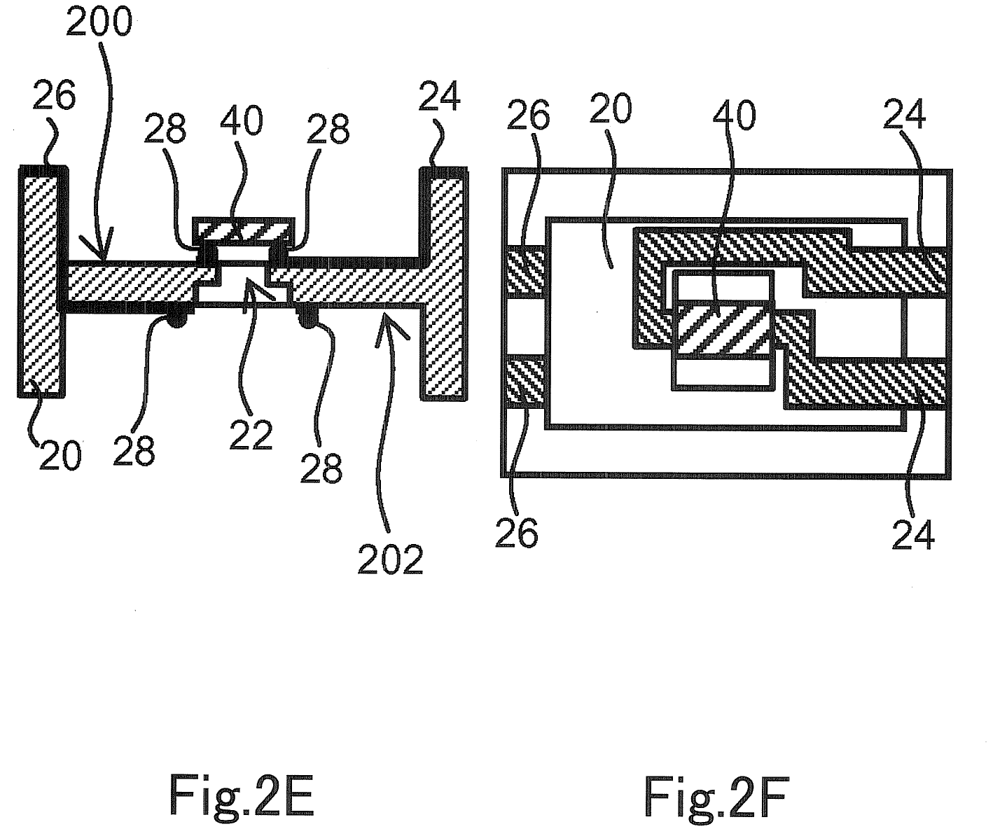

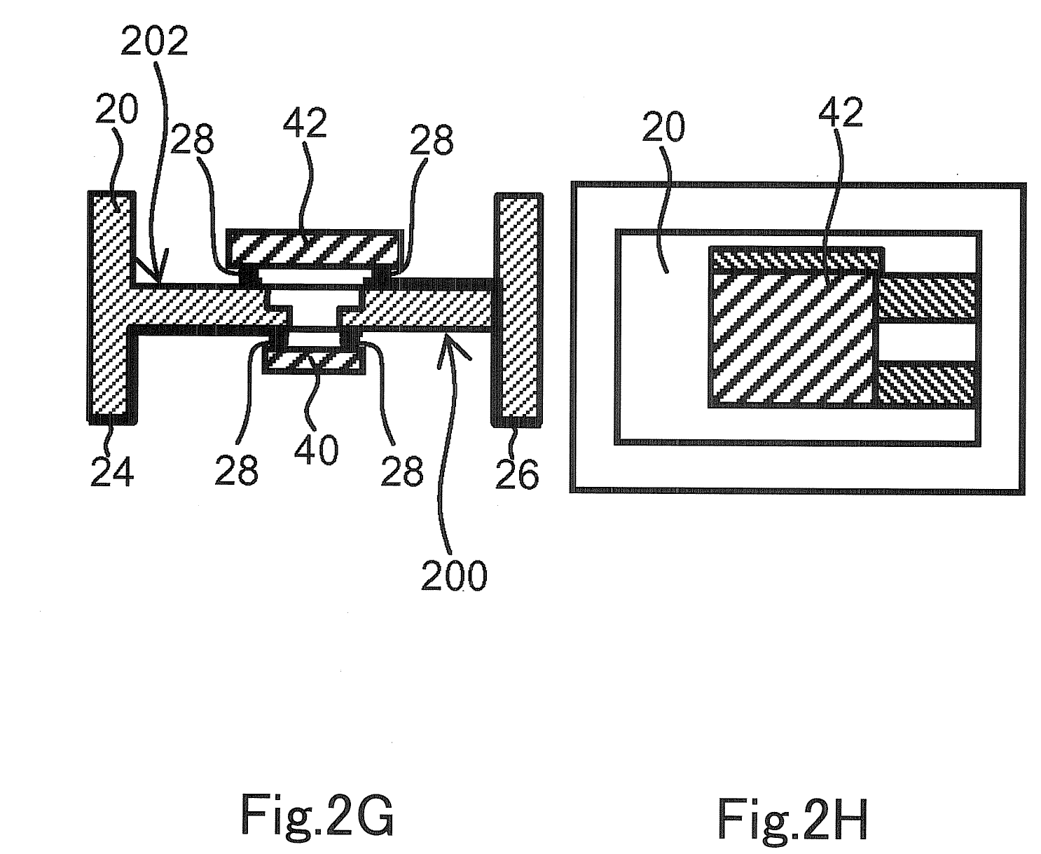

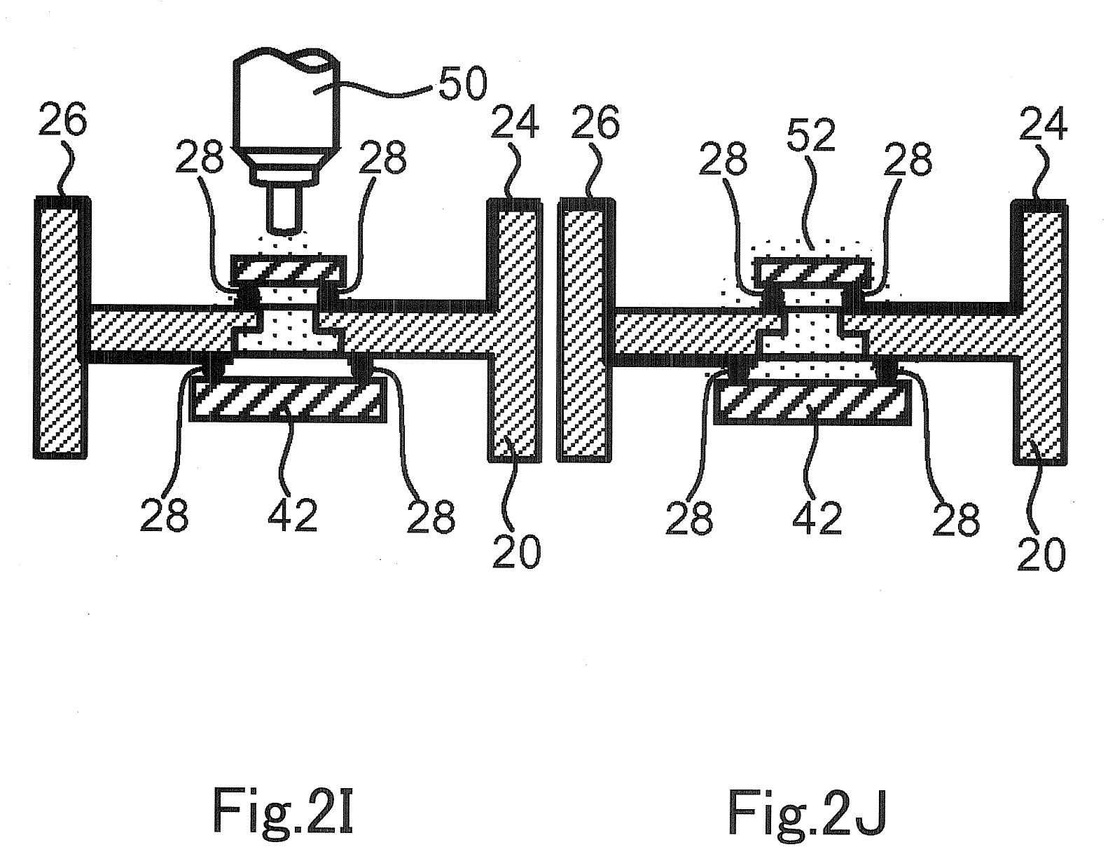

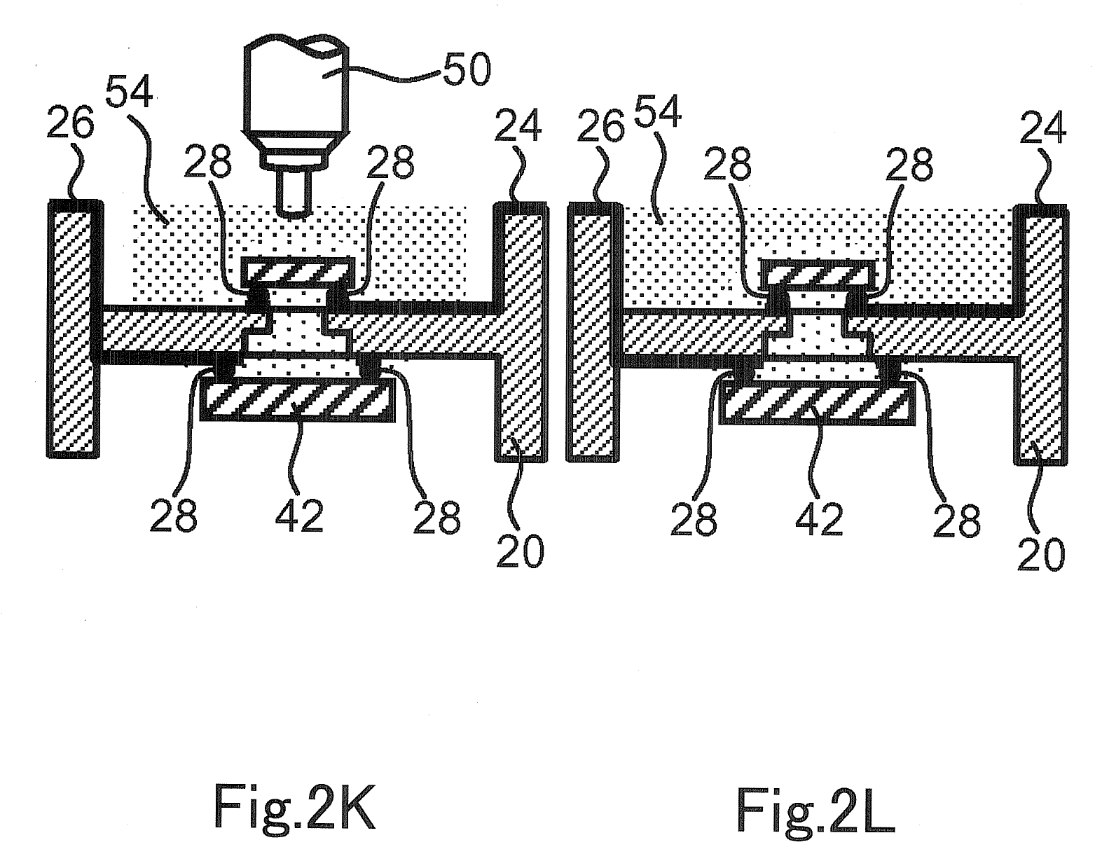

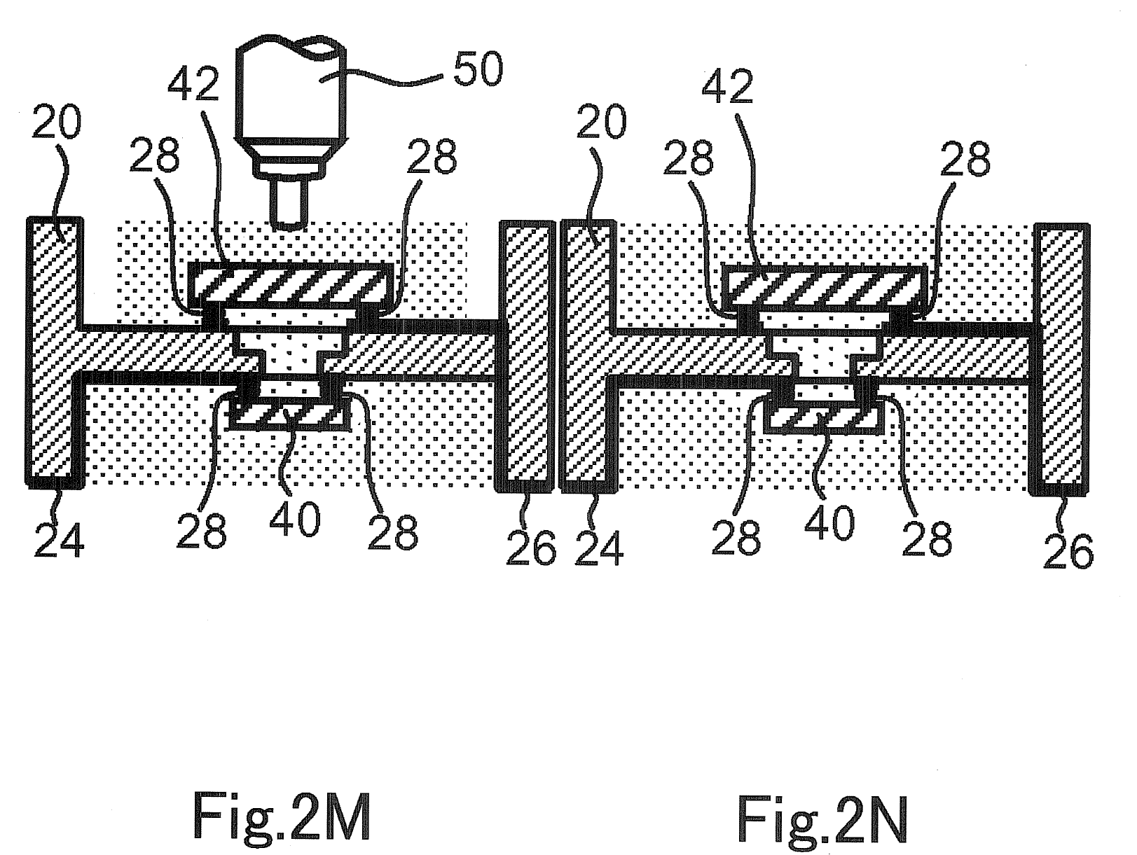

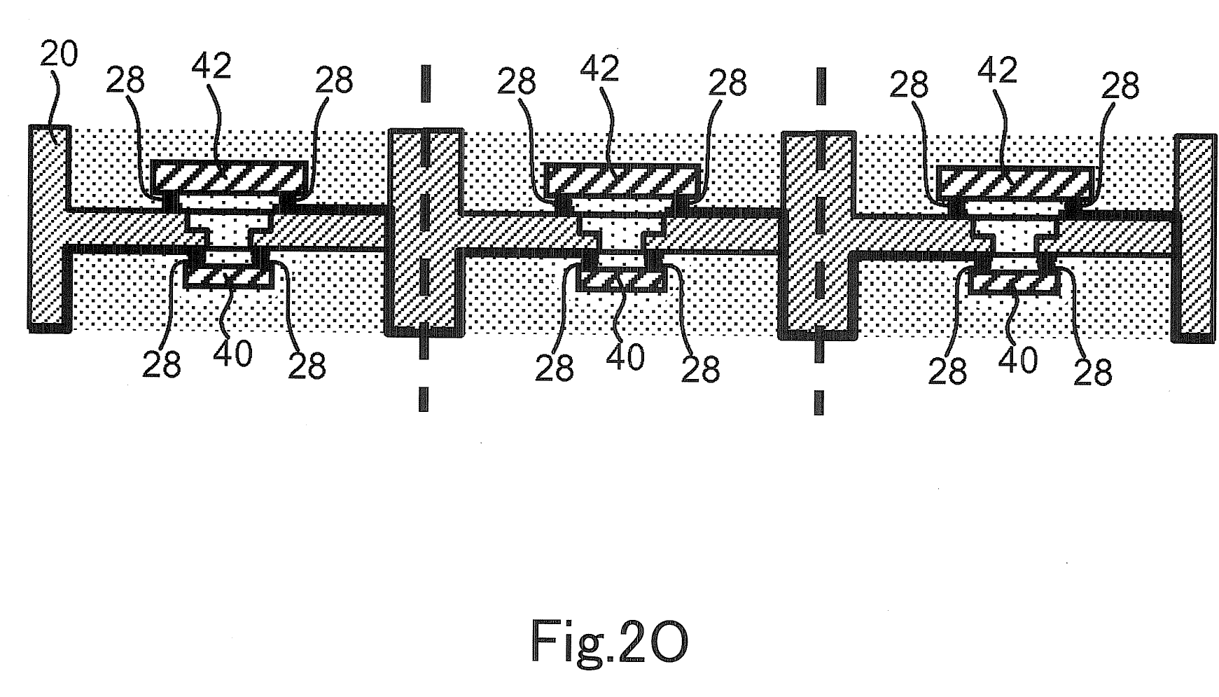

FIGS. 2A to 2O are schematic views showing production processes of the present embodiment. FIGS. 2A and 2B 20 show a process of forming the light emitting element bumps 28, and are respectively a schematic cross-sectional view and a schematic plan view.

On the first surface 200 of the supporting member 20, provided is the wiring layer 24 to be connected to two electrodes of the light emitting element 40. The wiring layer 24 adjacent to the opening portion 22 is set to be a light emitting element bump region, on which two ball-shaped bumps 28 are formed by using a conductive wire (such as a gold material) and a ball (a soldering material).

FIGS. 2C and 2D show a process of forming the bumps 28 for the light emitting element, and are respectively a schematic cross-sectional view and a schematic bottom view being the opposite side of FIG. 2B. On the second surface 202 of the supporting member 20, provided is the wiring layer 26 to be connected to two electrodes of the light receiving element 42, and two bumps 28 are provided 15 on the light receiving element bump region.

FIGS. 2E and 2F show a process of bonding the light emitting element 40 by flip chip bonding (FCB), and are respectively a schematic cross-sectional view and a schematic plan view.

FIGS. 2G and 2H show a process of bonding the light receiving element 42 by the FCB, and are respectively a schematic cross-sectional view and a schematic bottom view being the opposite side of FIG. 2F. The light emitting element 40 and the light receiving element 42 are bonded with the wiring layers 24 and 26 on the supporting member 20 by pressurization, heating, supersonic application, or the like. In addition, the light emitting element 40 and the light receiving element 42 are arranged so as to face with each other through the opening portion 22.

Next, FIGS. 2I and 2J are schematic cross-sectional views showing processes of primarily sealing a portion between the light emitting element 40 and the light receiving element 42 by the translucent resin 52. As shown in FIG. 21, the liquid translucent resin 52 like a silicone is injected between the light emitting element 40 and the light receiving element 42 by the potting method from a dispenser 50 to the inside of the supporting member 20, so that an optical path is formed as shown in FIG. 2J. In this case, since there is a case where the light emitting element 40 also emits light from a side surface thereof, it is preferable that the translucent resin 52 be injected from the light emitting 40 side to embed the light emitting element 40. On the other hand, as for the light receiving element 42, the translucent resin 52 is injected so as to cover a light receiving surface. Thereafter, the translucent resin 52 is thermally cured or UV-cured.

Next, FIGS. 2K and 2L are schematic cross-sectional views showing processes of injecting a liquid light shielding 5 resin 54 like epoxy by the potting method from the dispenser 50 to the inside of the supporting member 20. FIGS. 2M and 2N are schematic cross-sectional views showing processes of injecting the light shielding resin 54 into the inside of the supporting member 20 on the light receiving element 42 side. After being thermally cured, the light shielding resin 54 becomes as shown in FIG. 2N.

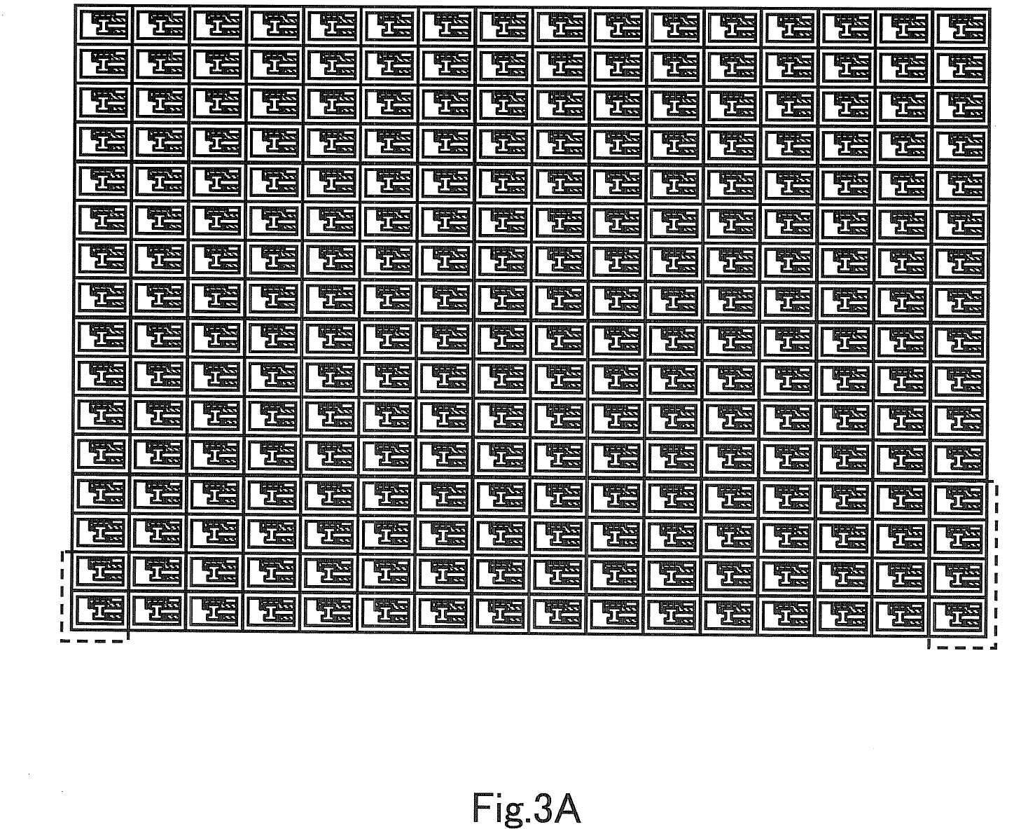

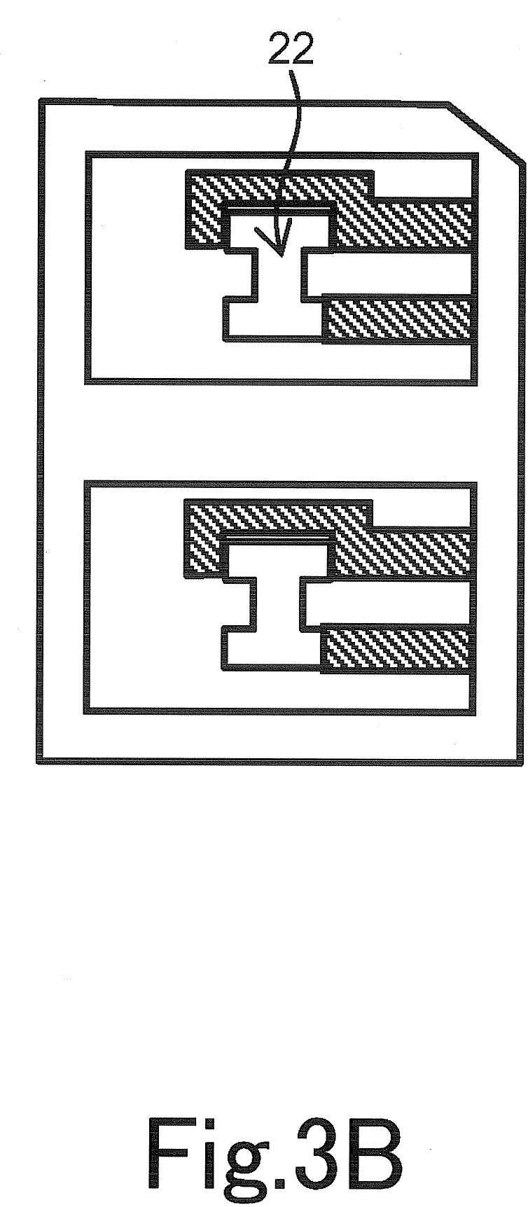

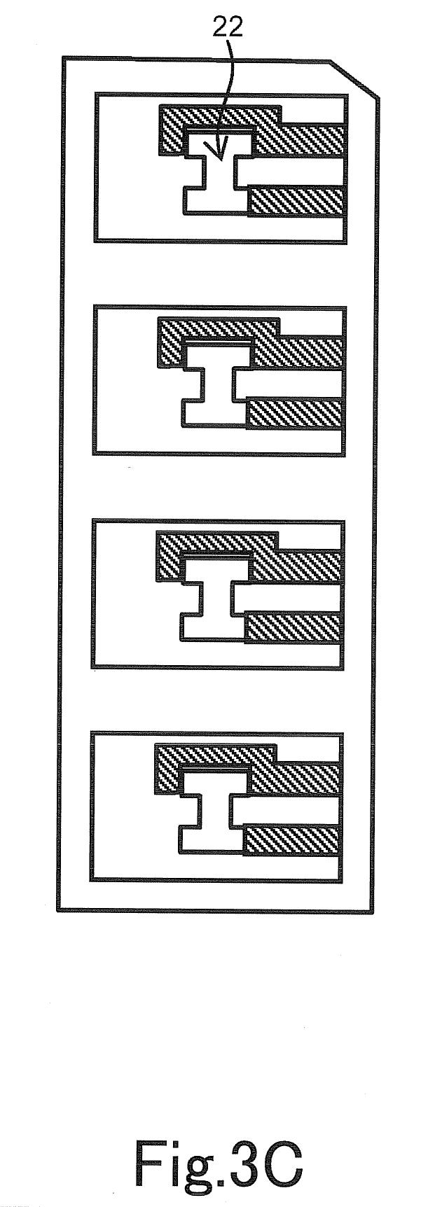

The processes of FIGS. 2A to 2N are performed as multiple-chip processing that is performed on the supporting members 20 connected to each other. FIG. 2O shows a connected state of the supporting members 20, and the supporting members 20 are divided by cutting positions of broken lines. FIG. 3A is a schematic plan view of the connected supporting members 20 in the state of FIGS. 2C and 2D in the manufacturing multiple-chip processing. FIG. 3 shows a state where 16×16=256 supporting members are integrated to each other. The processes of FIGS. 2A to 2O can be consistently performed in this state. Note that an optical coupling device having two channels can be formed by dividing the integrated chips by two connected chips by cutting as shown in FIG. 3B, and that an optical coupling device having four channels can be formed by dividing the integrated chips by four connected chips by cutting.

Since the supporting member 20 used in the present embodiment can be molded or processed before the light emitting element 40 and the light receiving element 42 are bonded, a thin material with excellent strength can be selected for the supporting member 20. Furthermore, it becomes easy to provide a smaller package by using the FCB.

### Modification of First Embodiment

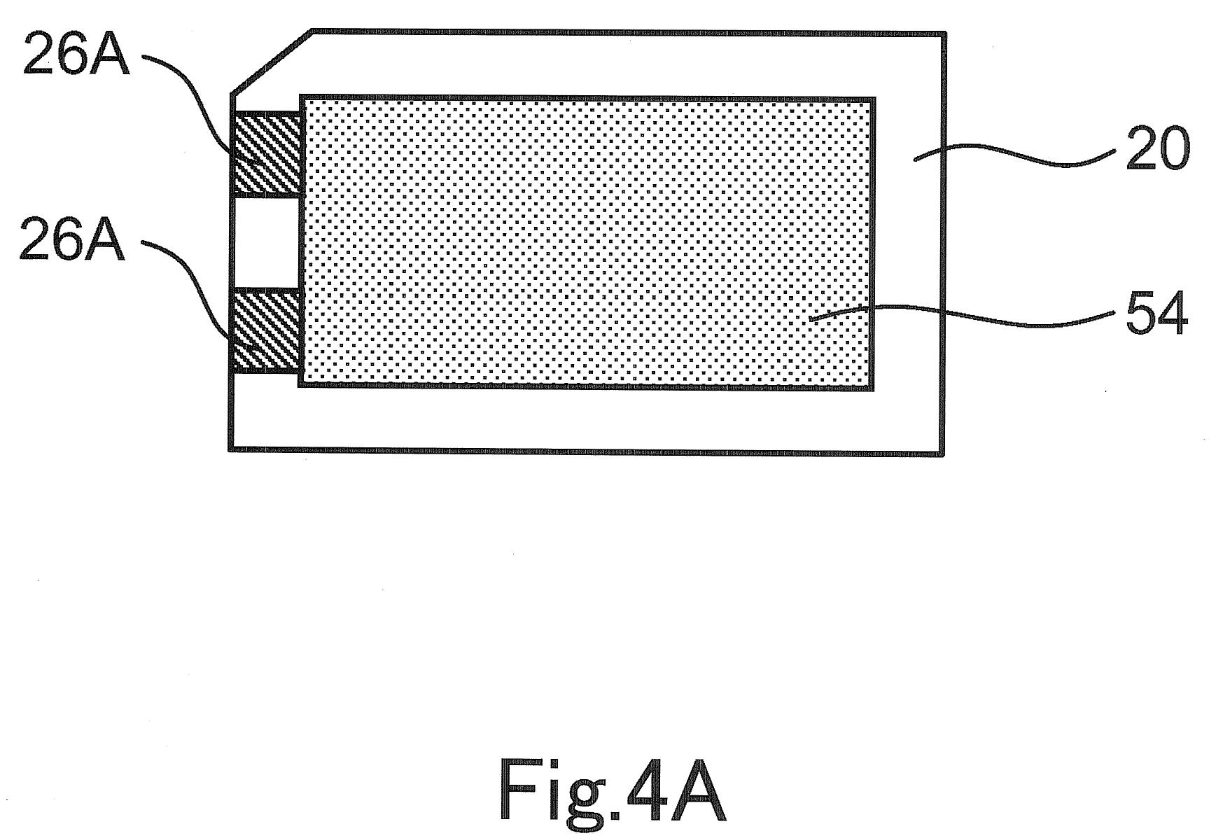

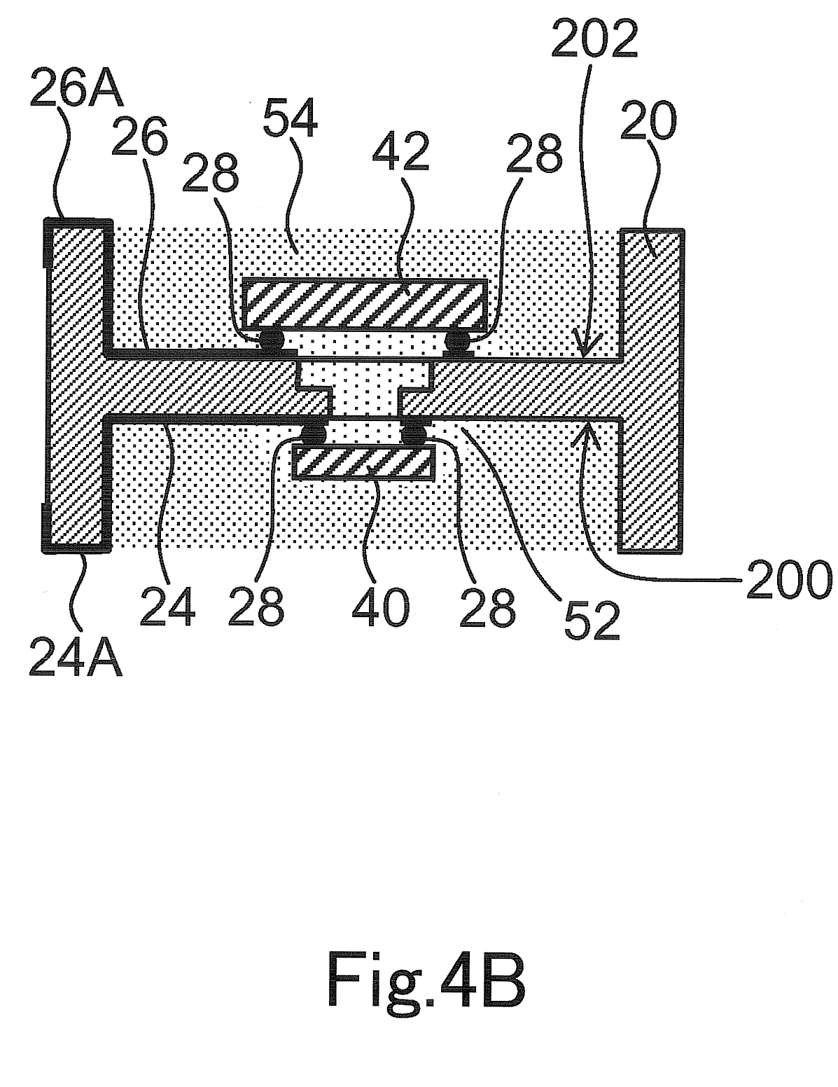

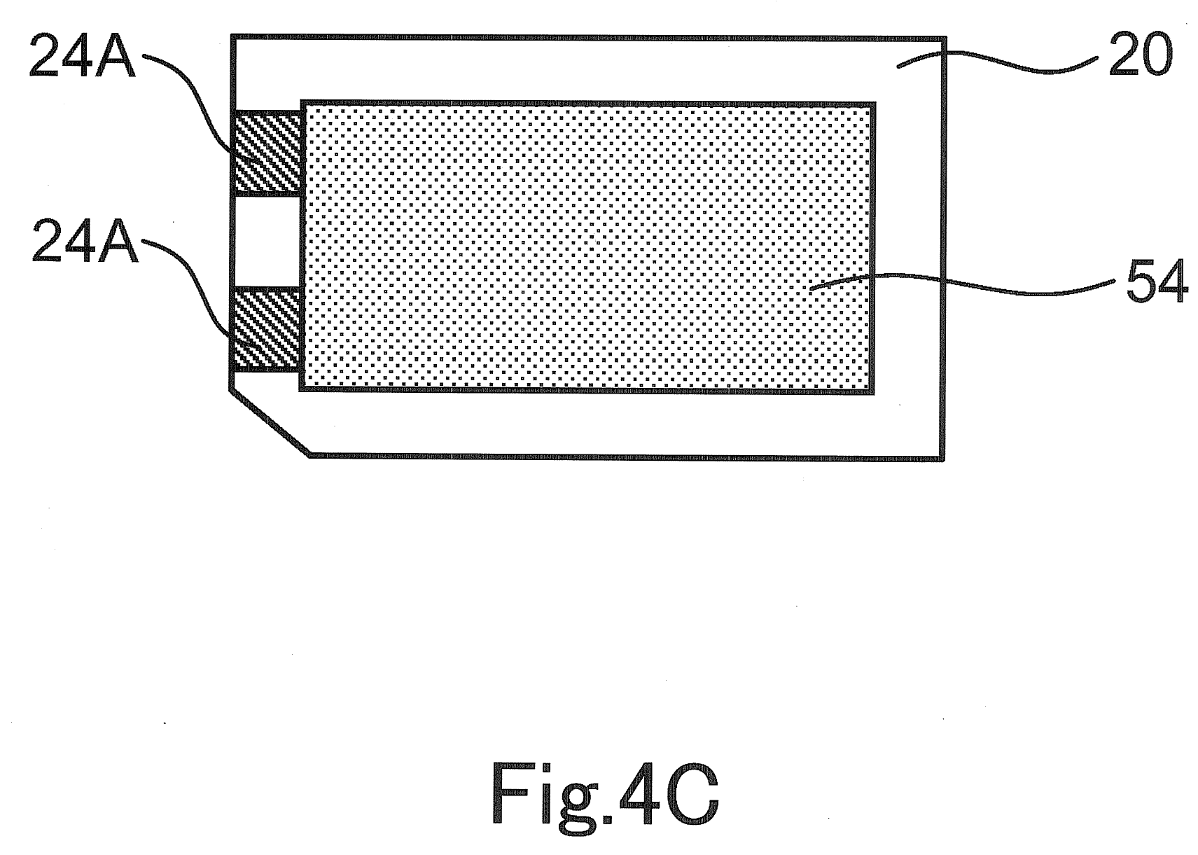

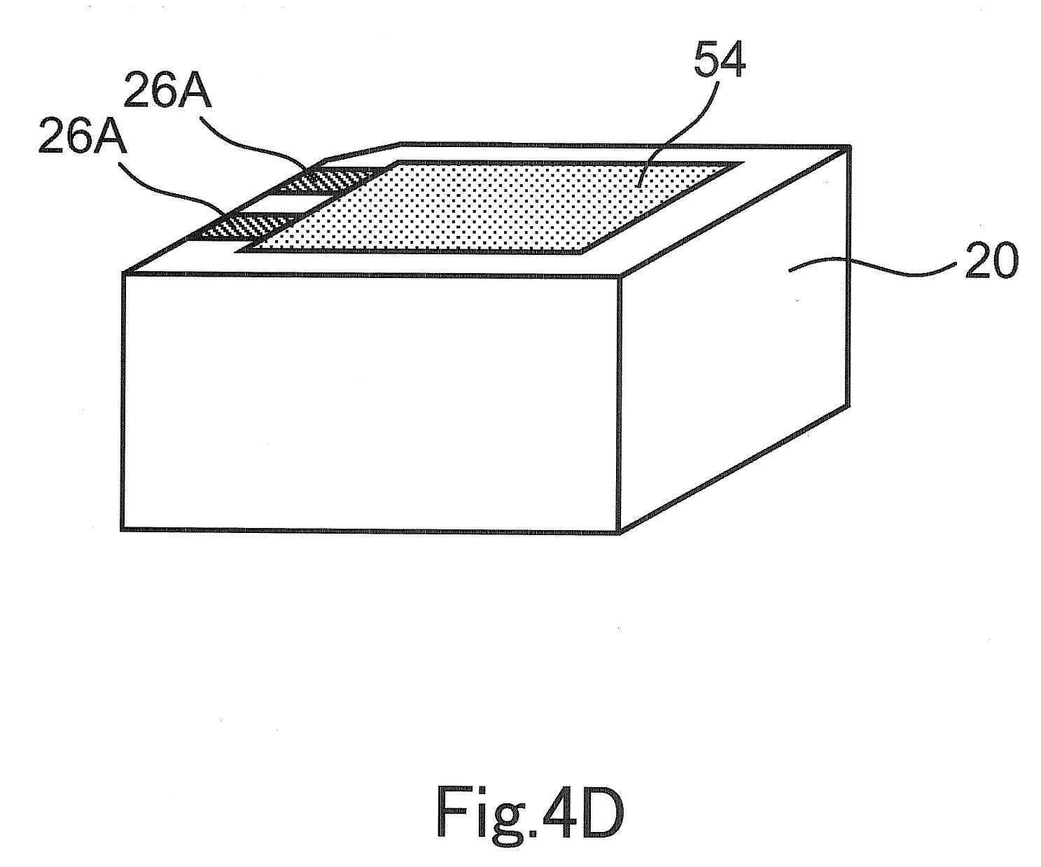

FIGS. 4A to 4D show a modification of the first embodiment. FIG. 4A is a schematic plan view. FIG. 4B is a schematic cross-sectional view. FIG. 4C is a schematic bottom view. FIG. 4D is a schematic perspective view.

In this modification, a light emitting element terminal 20 24A and a light receiving element terminal 26A being an output terminal are respectively provided on the bottom side of a supporting member 20 and the upper side of the supporting member. Since the other configuration is similar to that of the first embodiment, the description thereof will be omitted.

### SECOND EMBODIMENT

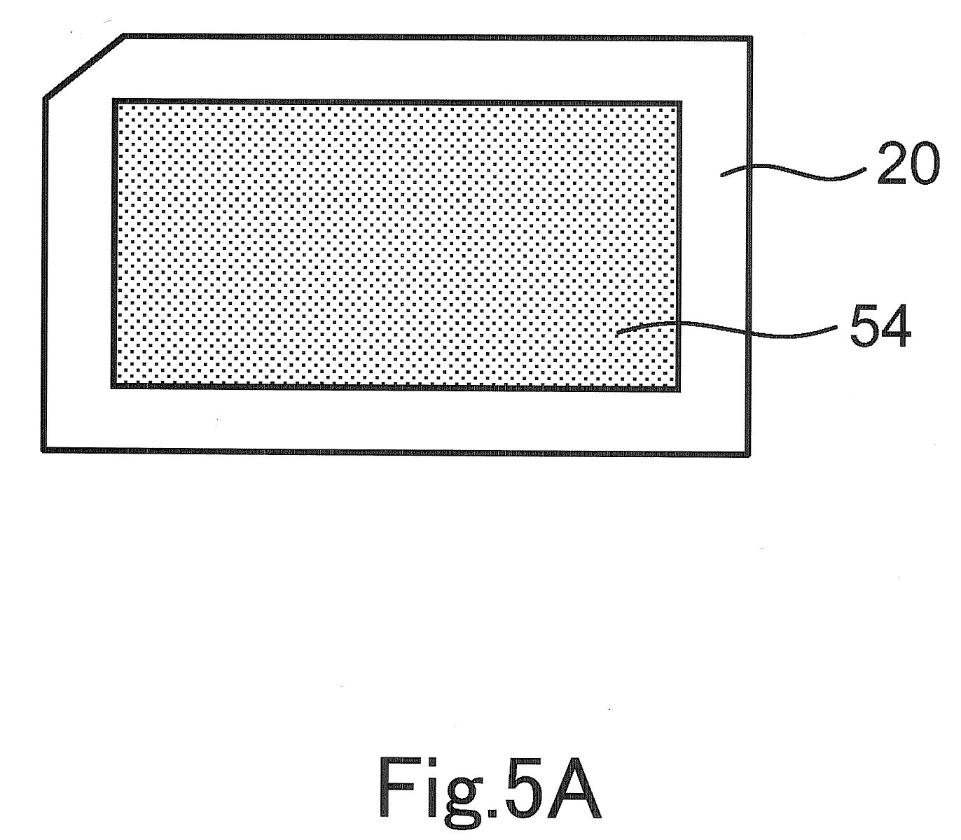

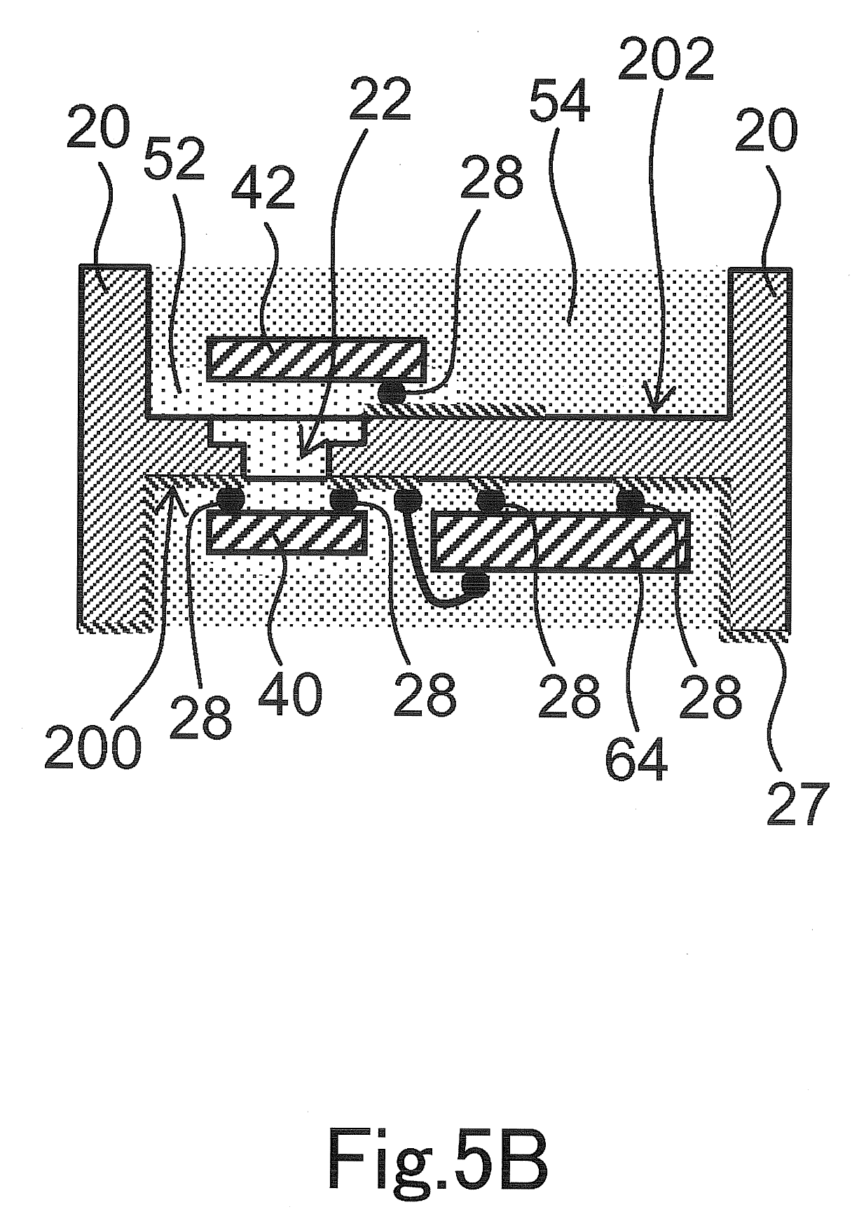

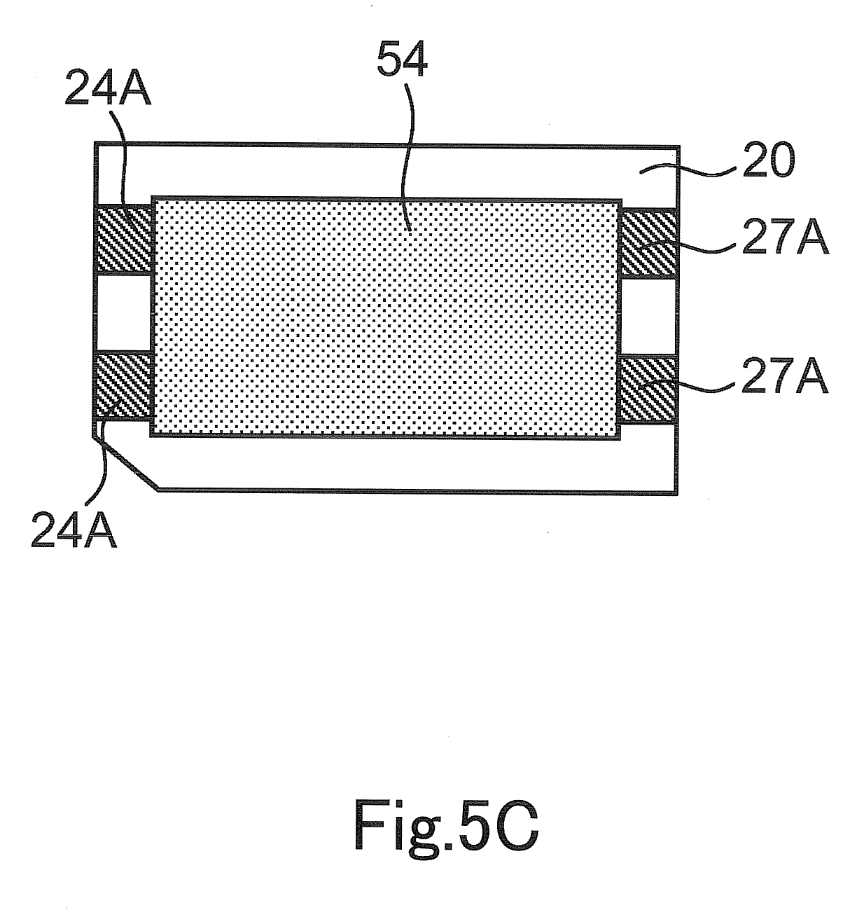

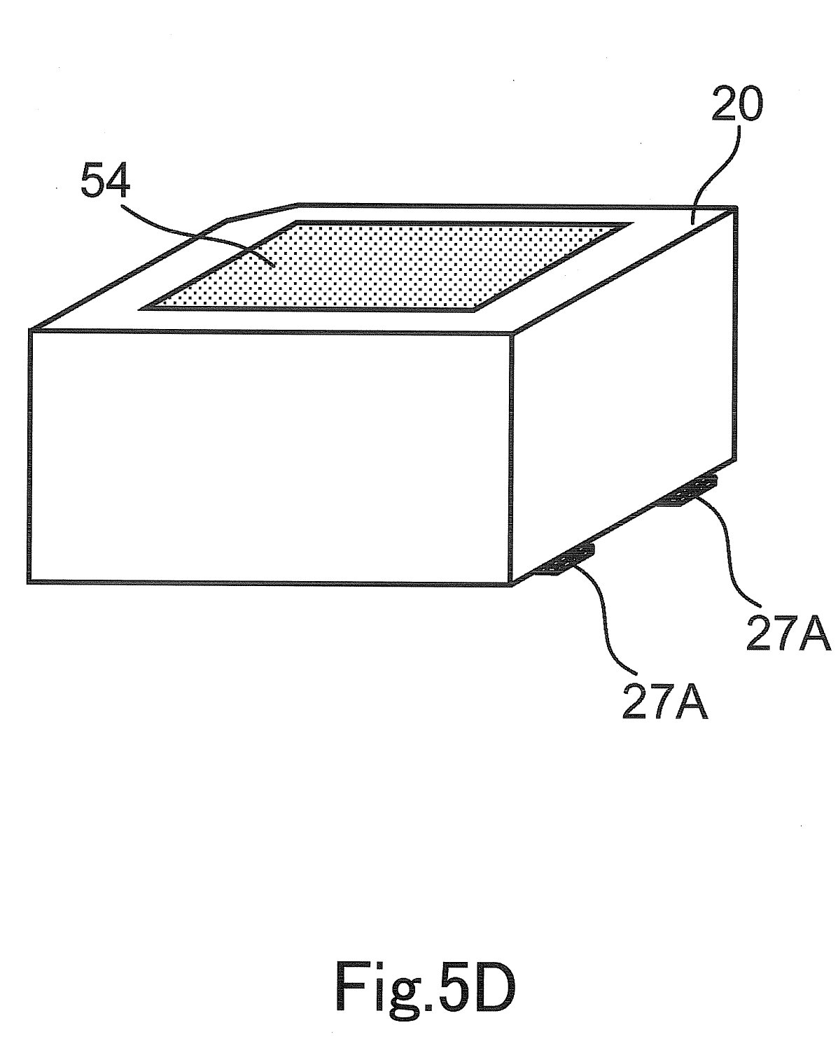

FIGS. 5A to 5E show an optical coupling device according 5 to a second embodiment of the present invention. FIG. 5A is a schematic plan view. FIG. 5B is a schematic cross-sectional view. FIG. 5C is a schematic bottom view. FIG. 5D is a schematic perspective view. FIG. 5E is an equivalent circuit view. Note that same reference numerals are given to the same components as those in FIGS. 1A to 1D, and detailed descriptions thereof will be omitted.

The optical coupling device according to the present embodiment is a photo-relay to switch a switching element such as a MOSFET 64 between a conductive state and a nonconductive state by optical excitation power thereof by using a photodiode array as a light receiving element 42. In FIG. 5B, under an opening portion 22, a light emitting element 40 and the MOSFET 64 are bonded with supporting members 20 by using bumps 28.

In addition, the light receiving element 42 that receives emitted light having passed through the opening portion 22 is bonded with the supporting member by using the bumps 28 so as to face the light emitting element 40. In the present embodiment, the light receiving element 42 is a photodiode array. When an input signal is added to a light emitting element terminal 24A to light the light emitting element 40, the emitted light enters the photodiode array through a translucent resin 52 being an optical path.

FIG. 5E shows an equivalent circuit view. In the photodiode array, for example, more than ten-odd photodiodes are serially connected, and an anode thereof is connected to a common gate of a pair of MOSFETs 64 at the output stage. In addition, a cathode is connected to a common source of the MOSFETs 64. Two drains of the MOSFETs 64 are output terminals 27A.

Electric charges are accumulated in the gates of the MOSFETs 64 by photocurrent generated in the photodiode array, so that the MOSFETs 64 become conductive. On the other hand, when the light emitting element 40 is put off, the electric charges accumulated in the gates of the MOSFETs 64 are discharged, and the MOSFETs 64 become nonconductive. In this manner, the photo-relay is switched between a turned-on state and a turned-off state to receive a signal from the output terminals 27A, so that the signal can be transmitted/received in a state where a power system is insulated.

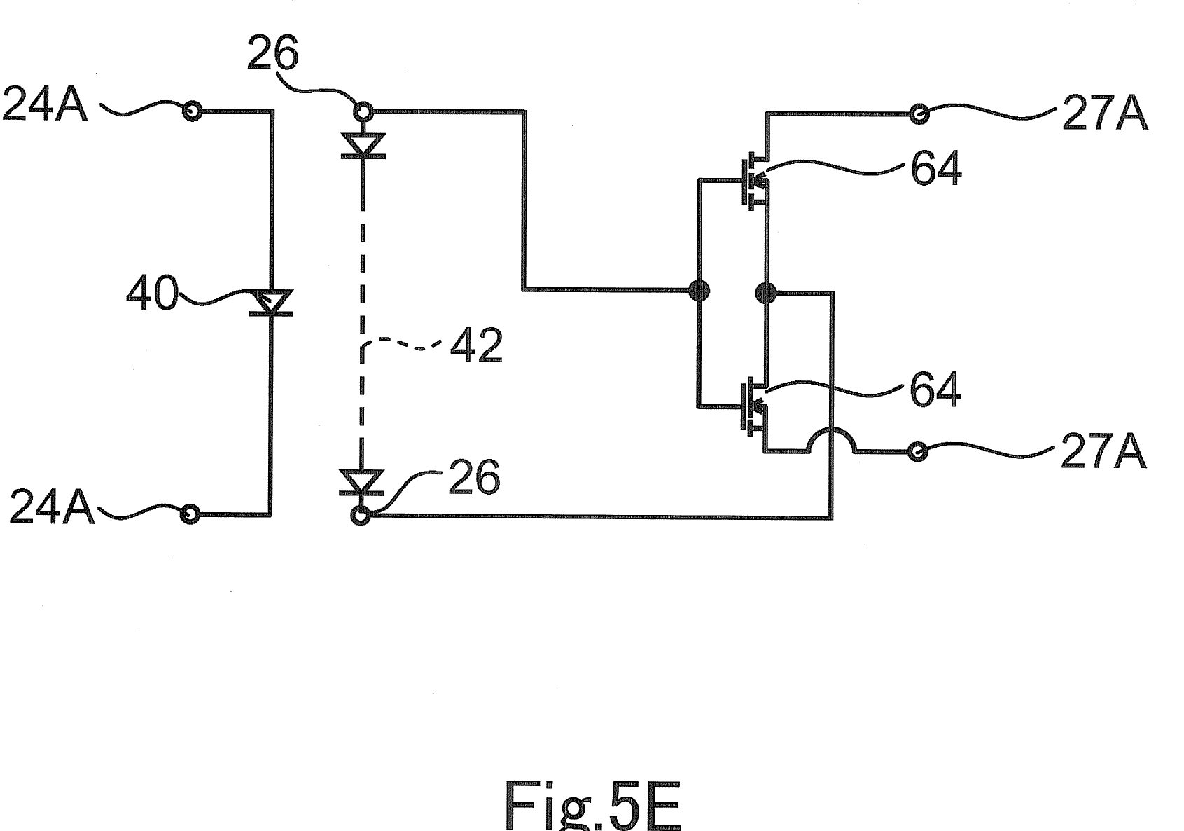

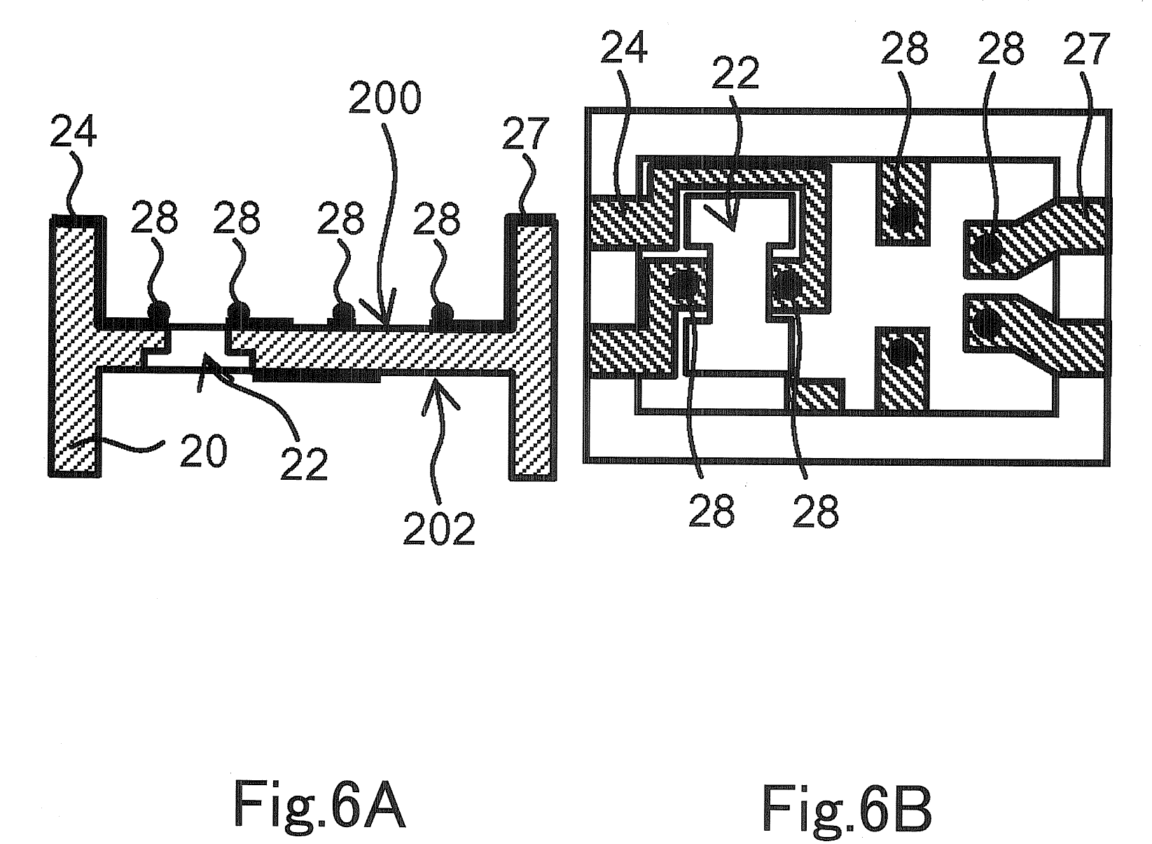

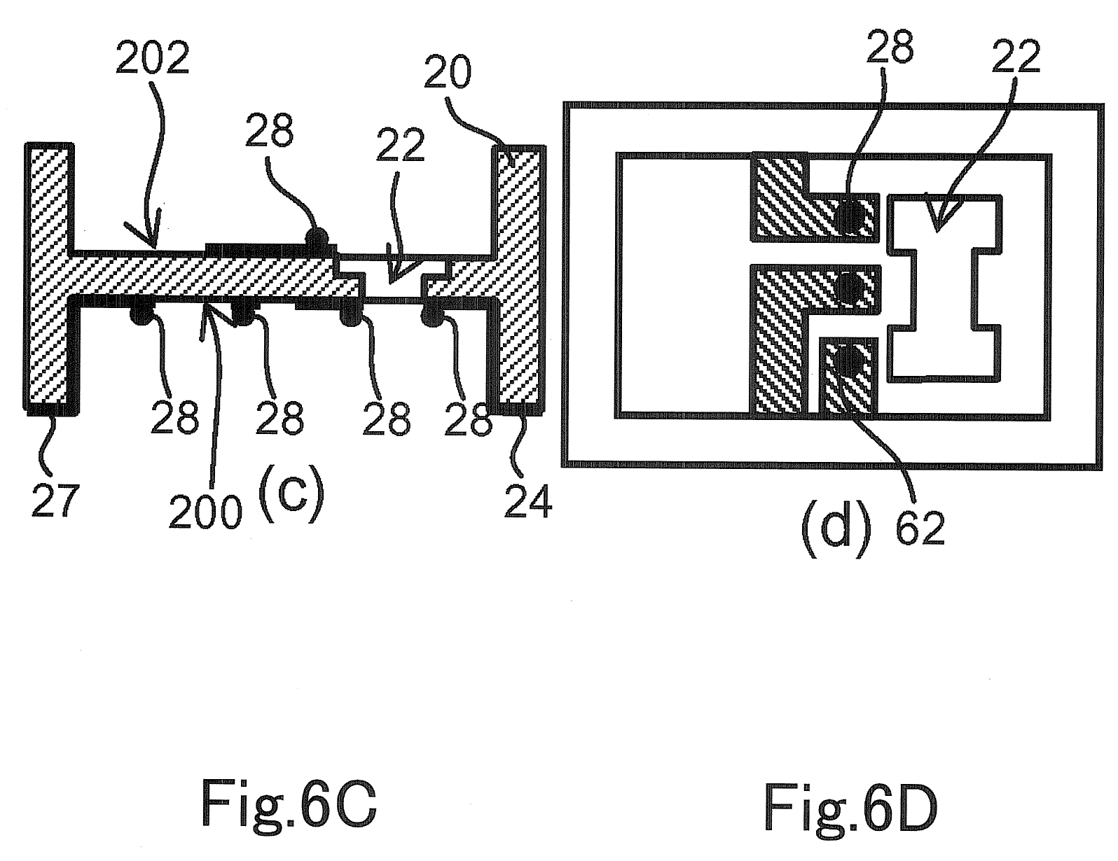

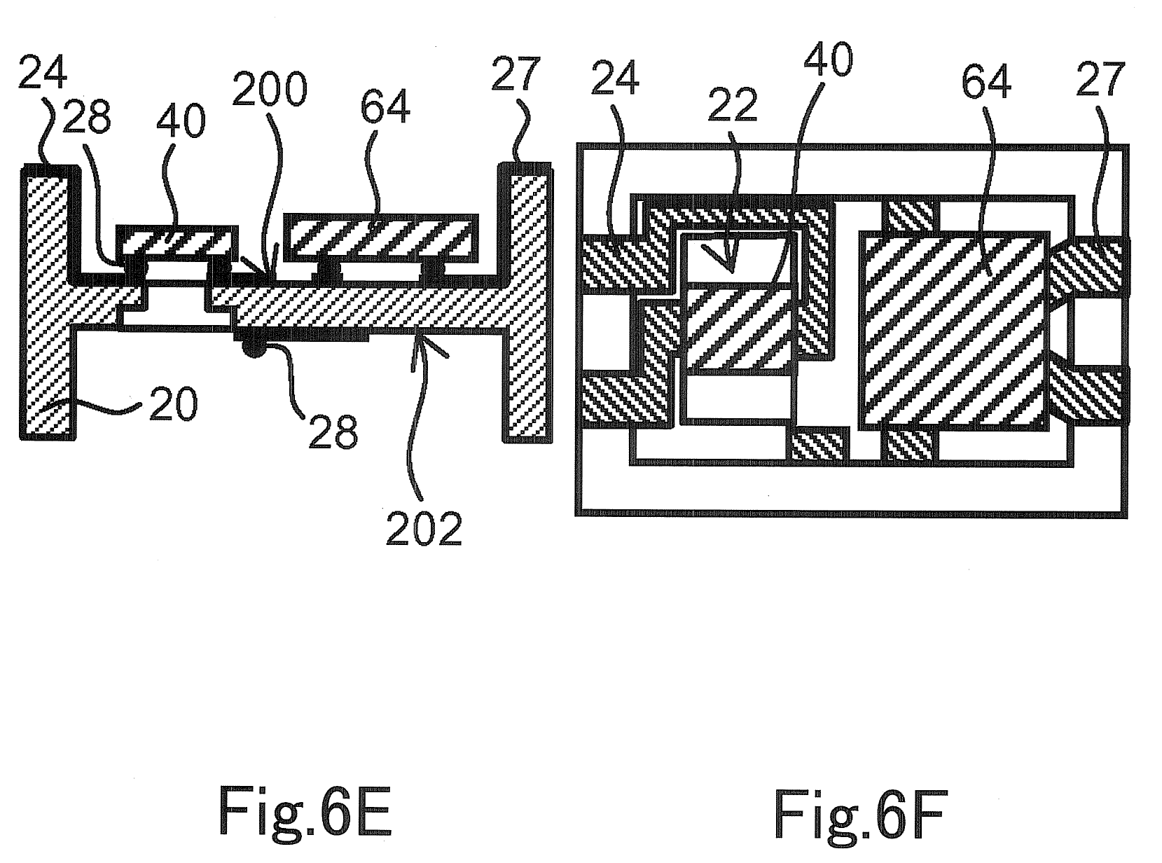

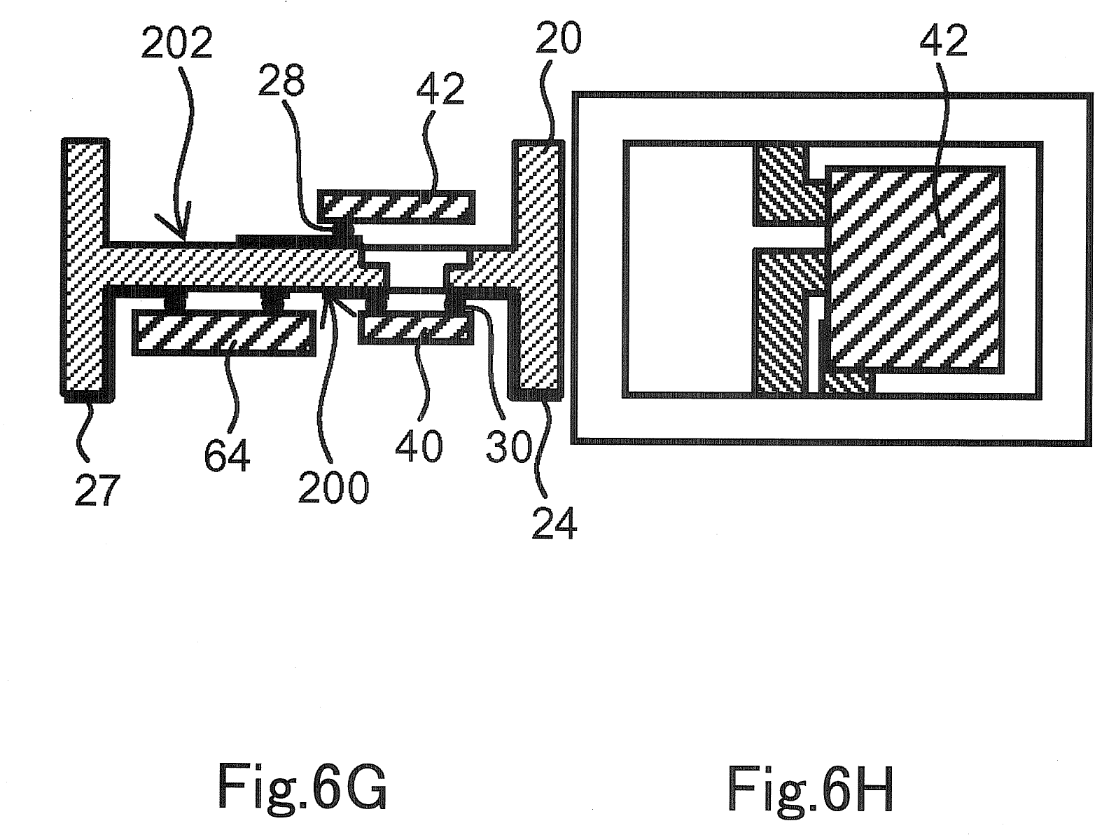

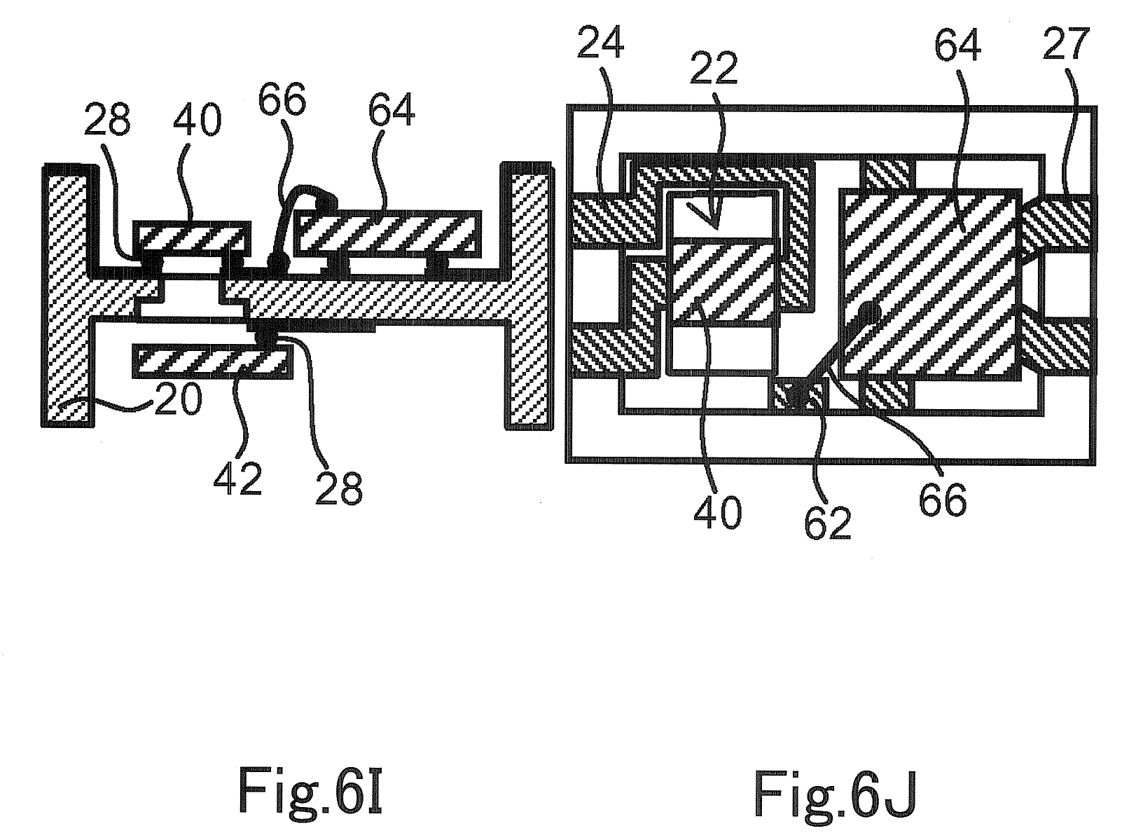

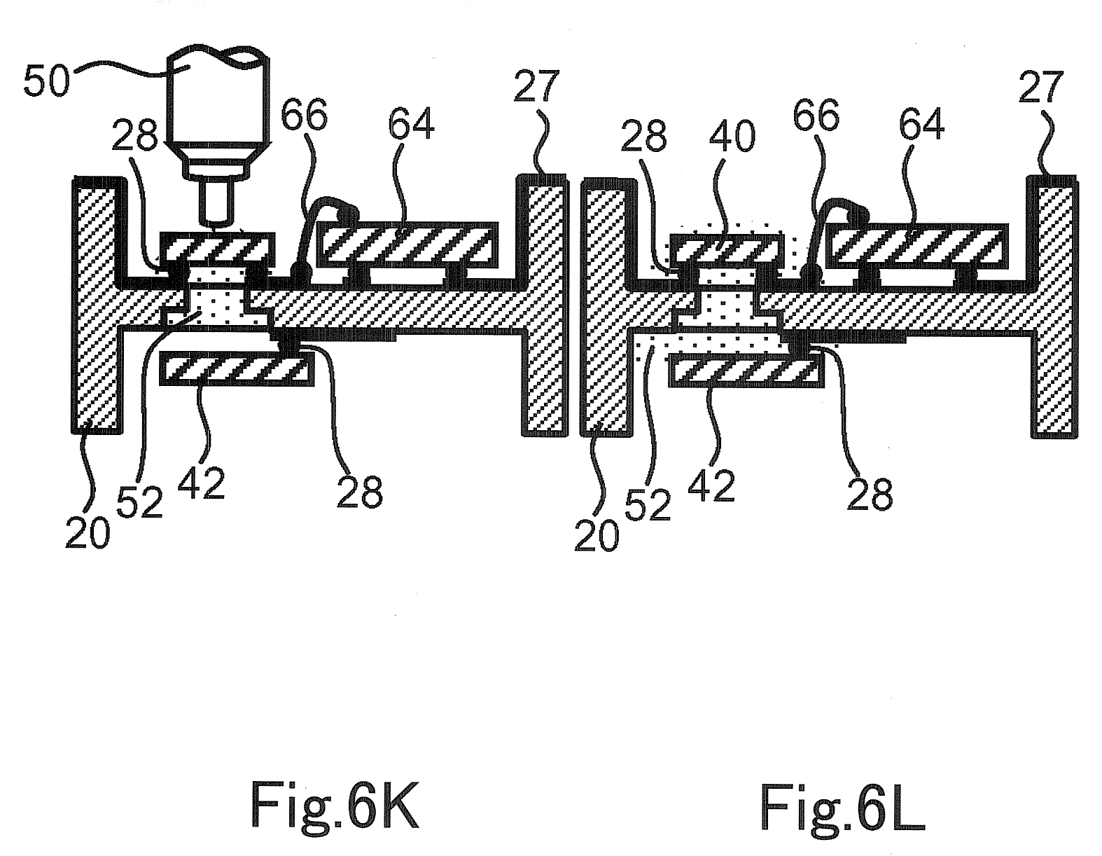

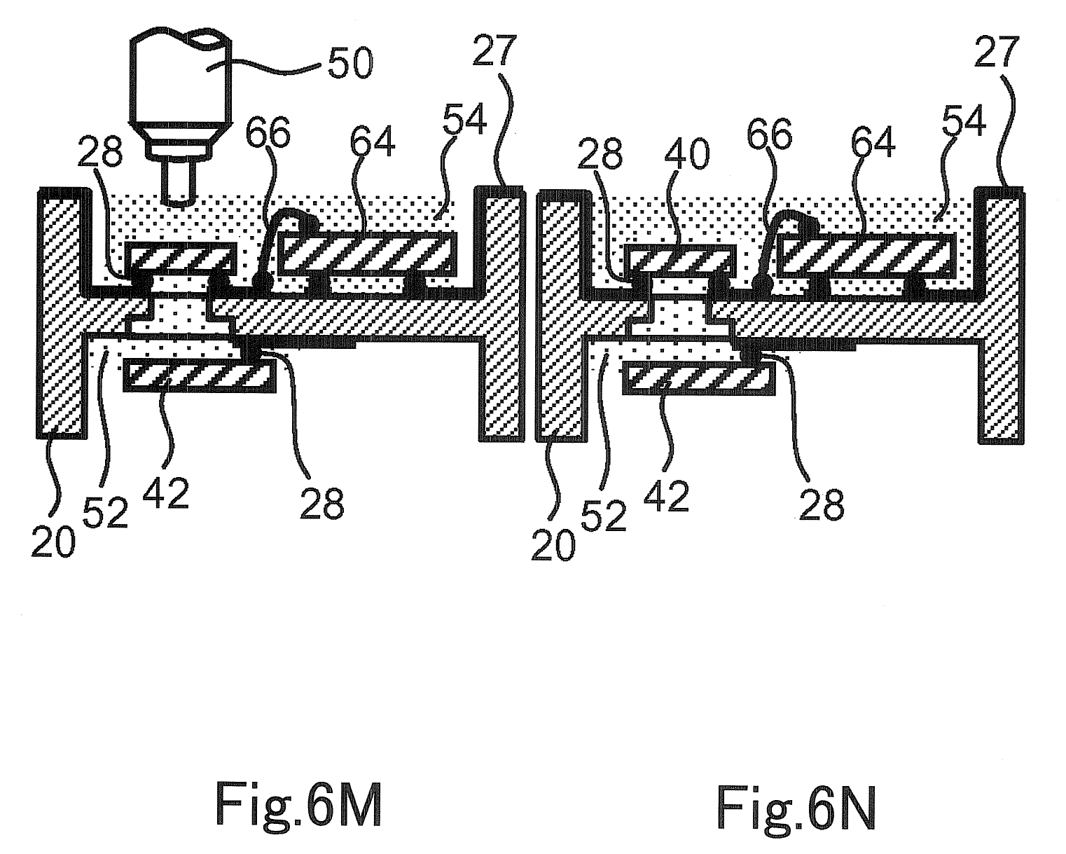

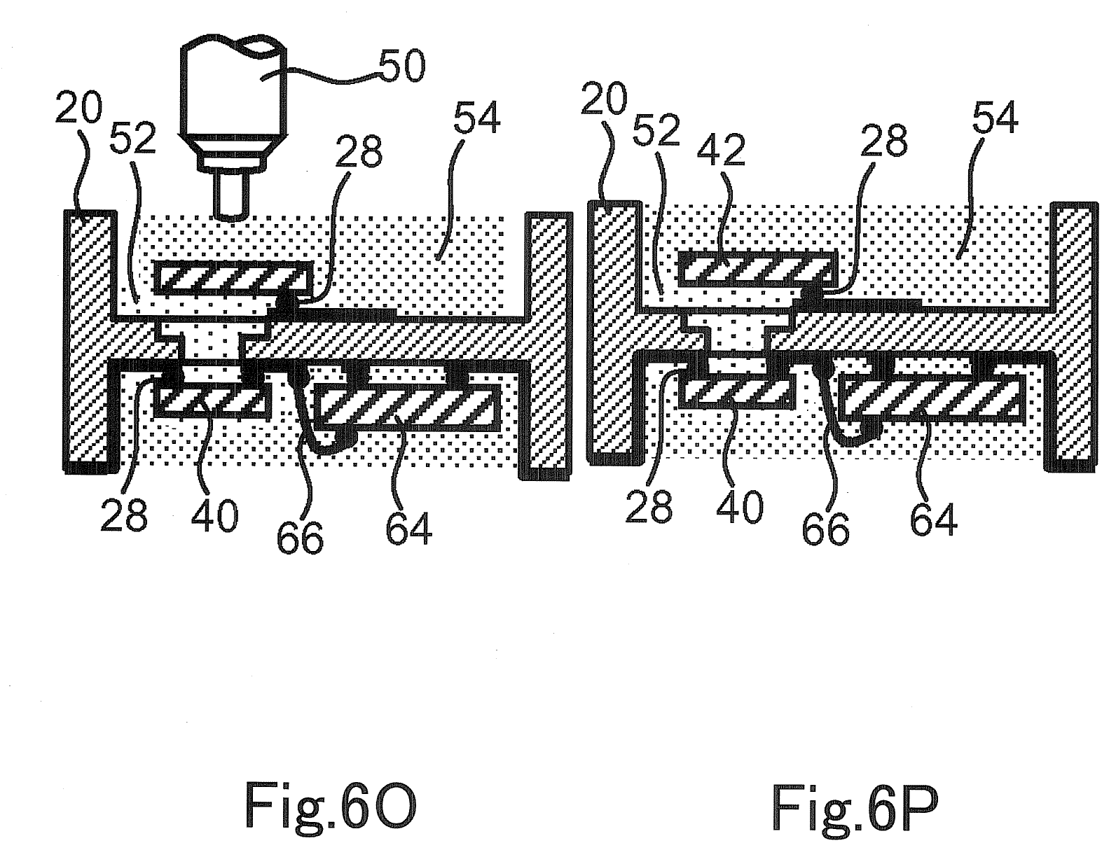

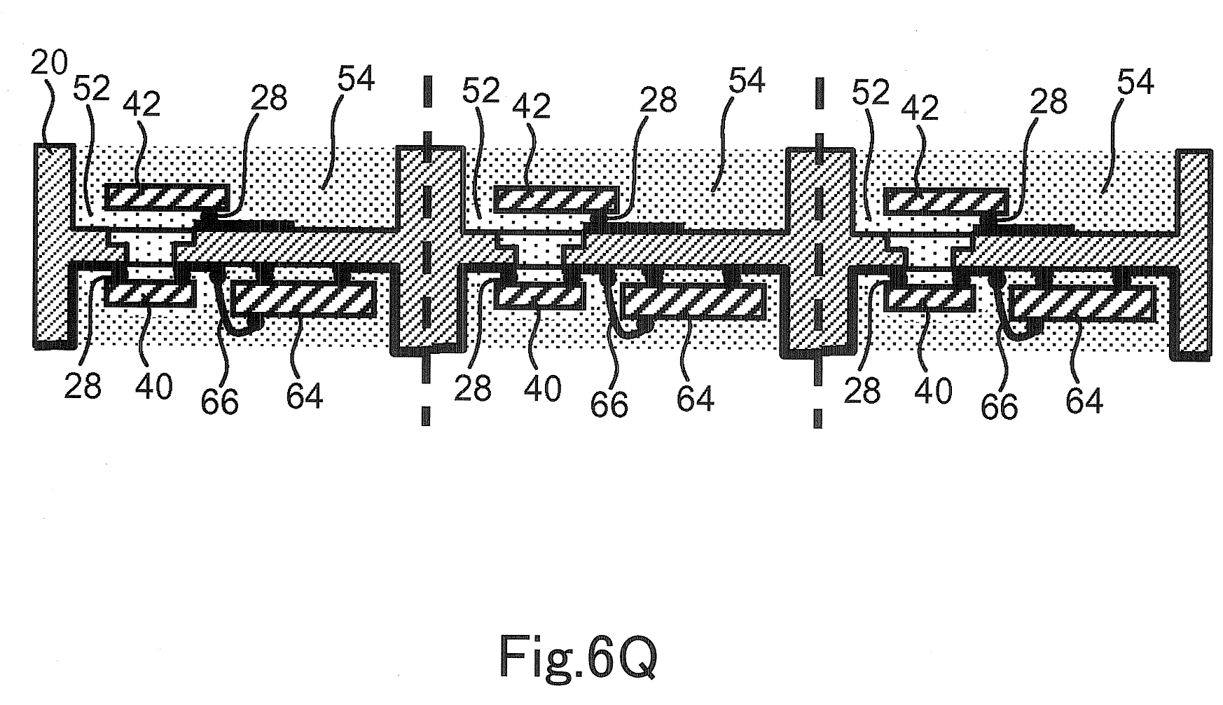

FIGS. 6A to 6Q are schematic views showing production processes of the present embodiment. Note that same reference numerals are given to the same components as those in FIGS. 2A to 2O, and detailed descriptions thereof will be omitted. FIGS. 6A and 6B show a process of forming bumps 28 for the light emitting element and bumps 28 for the MOSFET 64, and are respectively a schematic cross-sectional view and a schematic plan view.

On a first surface 200 of the supporting member 20, wiring layers 24 and 27 are provided. The wiring layer 24 adjacent to the opening portion 22 is set to be a light emitting element bump region, on which two ball-shaped bumps 28 are formed by using a conductive wire (such as a gold material) and a ball (a soldering material). In addition, on the MOSFET bump region of the wiring layer 27 on the same surface, four bumps 28 are similarly formed.

FIGS. 6C and 6D show a process of forming bumps 28 for the light receiving element, and are respectively a schematic cross-sectional view and a schematic bottom view. On a second surface 202 of the supporting element 20, provided are a wiring layer to be connected to two electrodes of the light receiving element 42 and a MOSFET backside element bump region thereof, two bumps 28 are formed, and one bump 28 is formed on the MOSFET backside connecting portion 62.

FIGS. 6E and 6F show a process of bonding the light emitting element 40 and the MOSFET 64 by flip chip bonding (FCB), and are respectively a schematic cross-sectional view and a schematic plan view.

FIGS. 6G and 6H show a process of bonding the light receiving element 42 by the FCB, and are respectively a schematic cross-sectional view and a schematic bottom view. The light emitting element 40 and the light receiving element 42 are arranged so as to face with each other through the opening portion 22.

Next, FIGS. 6I and 6J show a process of bonding the backside of the MOSFET 64 and the MOSFET backside connecting portion 62 by a bonding wire 66, and are respectively a schematic cross-sectional view and a schematic plan view. The backside of the MOSFET 64 is connected to the anode of the photodiode array being the light receiving element 42 through the backside connecting portion 62 to shorten switching time by reducing the capacity of the MOSFET 64.

FIGS. 6K and 6L are schematic cross-sectional views showing processes of primarily sealing a portion between the light emitting element 40 and the light receiving element 42 by the translucent resin 52.

Next, FIGS. 6M and 6N are schematic cross-sectional views showing processes of injecting a light shielding resin 54 into the inside of the supporting member 20 on the light emitting element 40 side. Furthermore, FIGS. 6O and 6P are schematic cross-sectional views showing processes of injecting the light shielding resin 54 into the inside of the supporting member 20 on the light receiving side 42 side. After being thermally cured, the light shielding resin becomes as shown in FIG. 6Q. The processes of FIGS. 6A to 6P are performed in a multi-chip processing performed on the connected supporting members. FIG. 6Q shows a connected state of the supporting members, and the supporting members are divided by cutting positions of broken lines.

Since the photo-relay of the second embodiment also has a configuration similar to that of the first embodiment, it becomes easy to be miniaturized. Since the photo-relay is easy to provide higher reliability than a mechanical-relay, usage thereof is expanding to fields of IC testers, measuring equipment, modems, and the like. In such usage, the number of photo-relays used for one system is large, and there is even a case where the number becomes a few thousand. In such case, a smaller system can be achieved by providing a smaller package.

### Modification of Second Embodiment

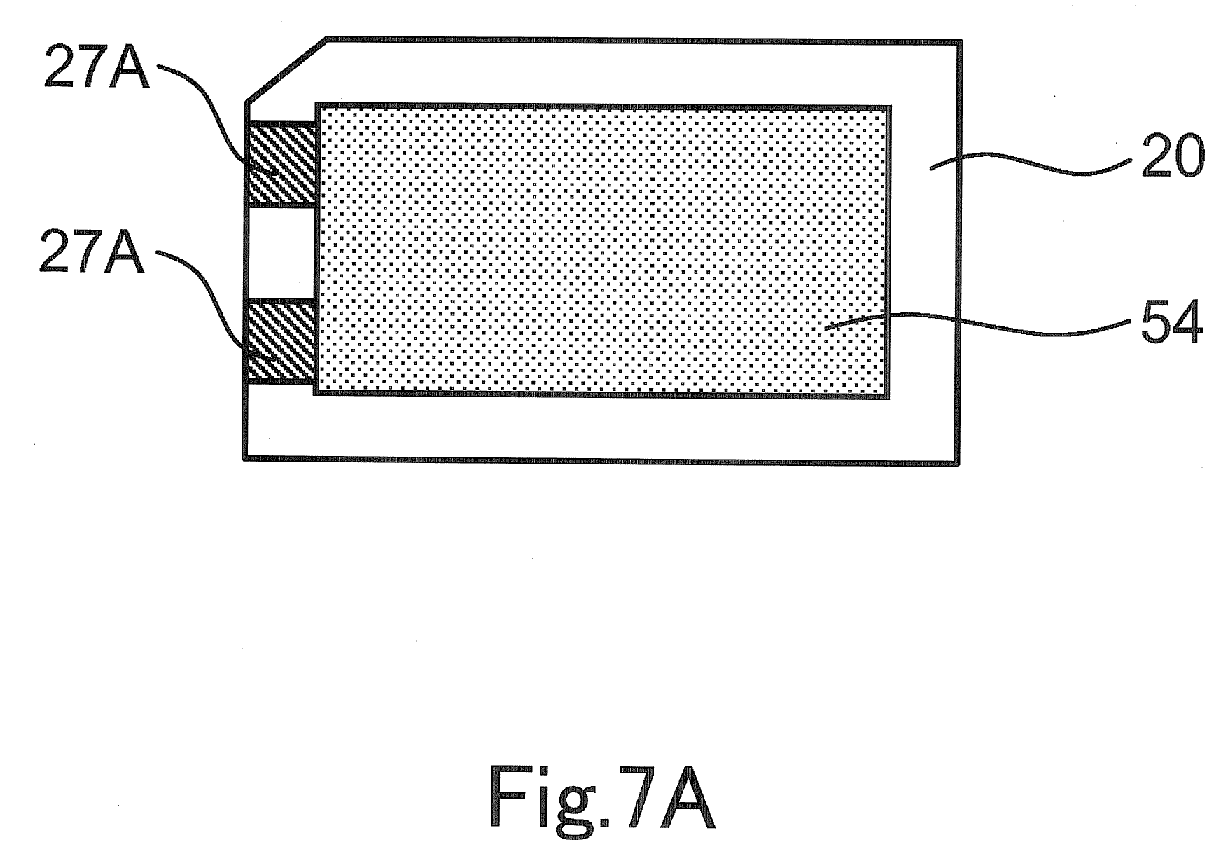

FIGS. 7A to 7D show a photo-relay which is a modification of the second embodiment. FIG. 7A is a schematic plan view. FIG. 7B is a schematic cross-sectional view. FIG. 7C is a schematic bottom view. FIG. 7D is a schematic perspective view. Note that same reference numerals are given to the same components as those in FIGS. 4A to 4D, and detailed descriptions thereof will be omitted.

The present modification is different from the second 10 embodiment in that a photodiode array and a MOSFET 64 are arranged on the same side as a supporting member 20.

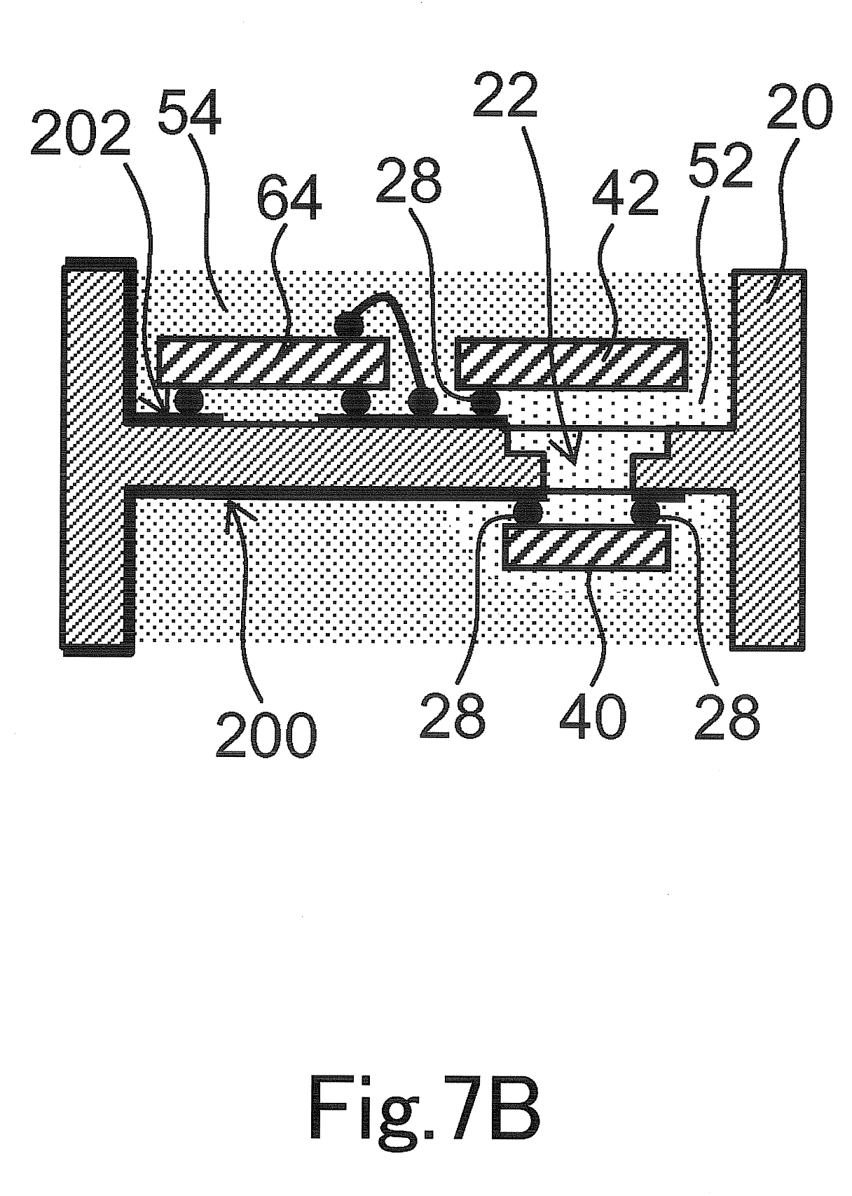

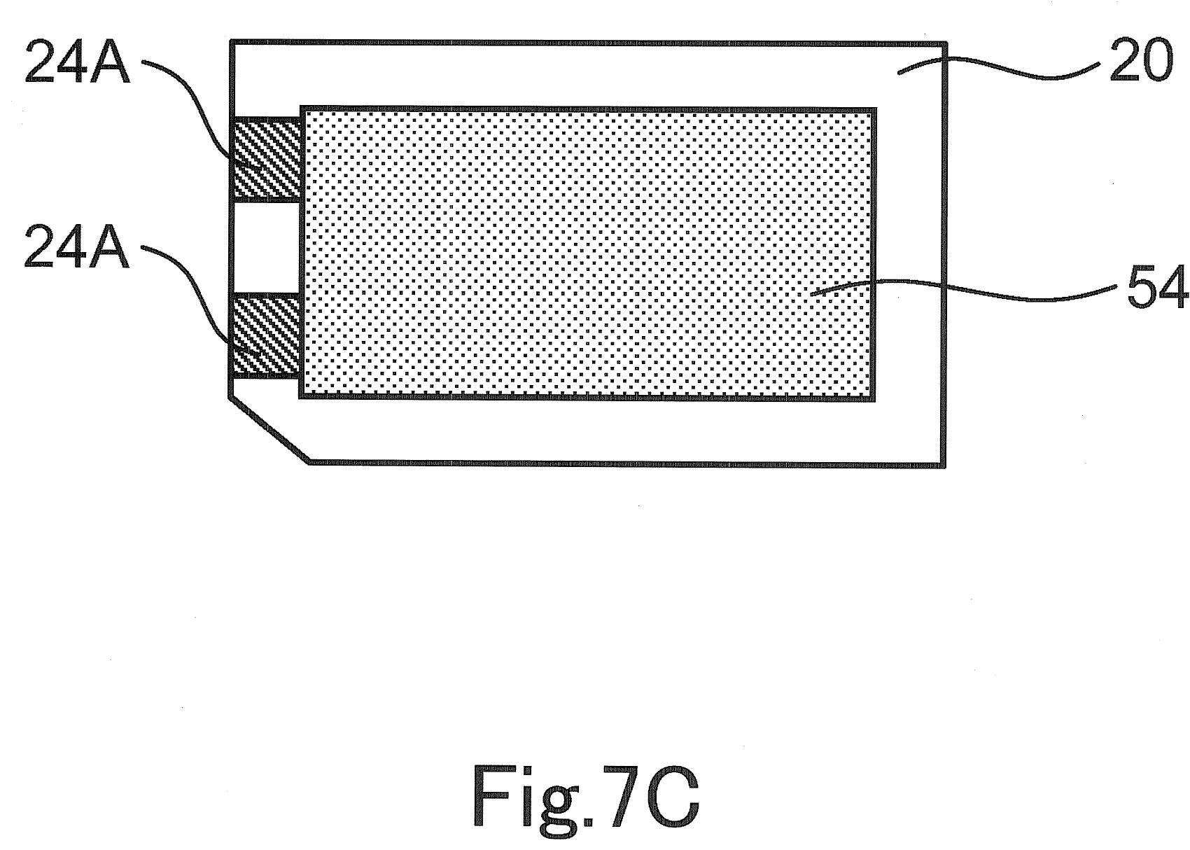

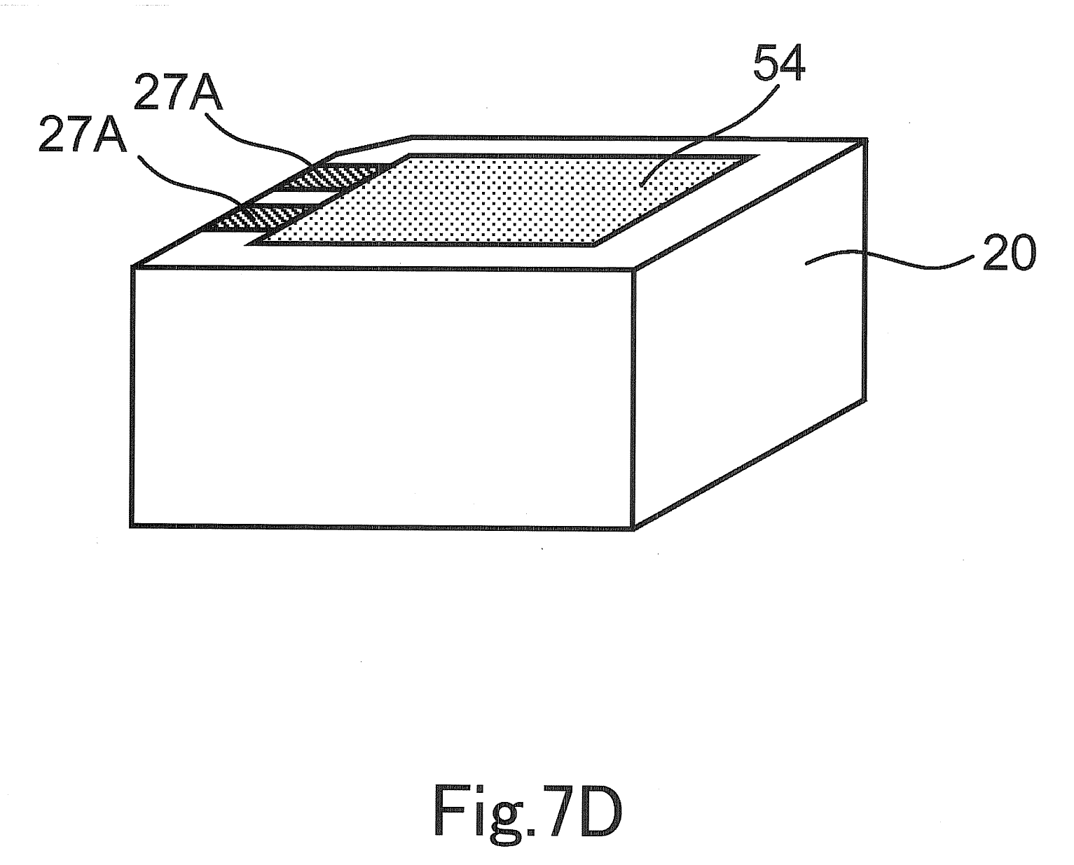

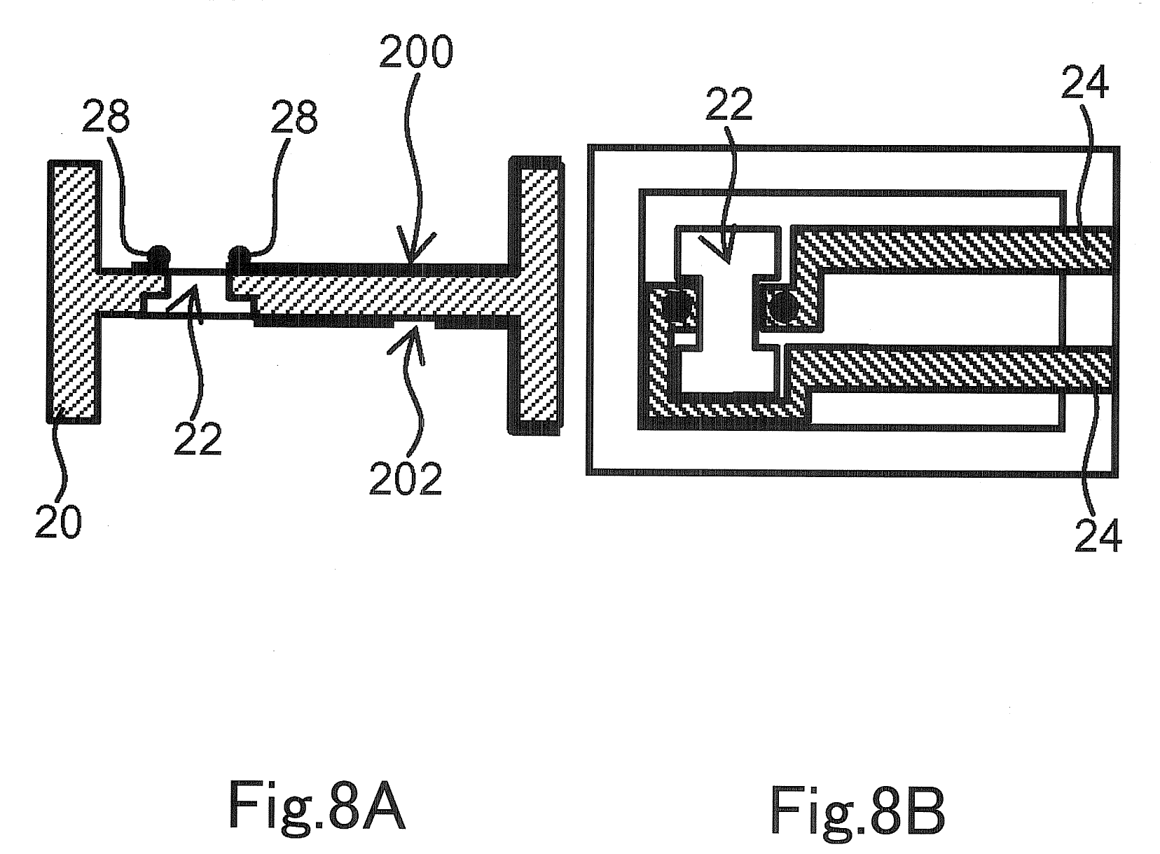

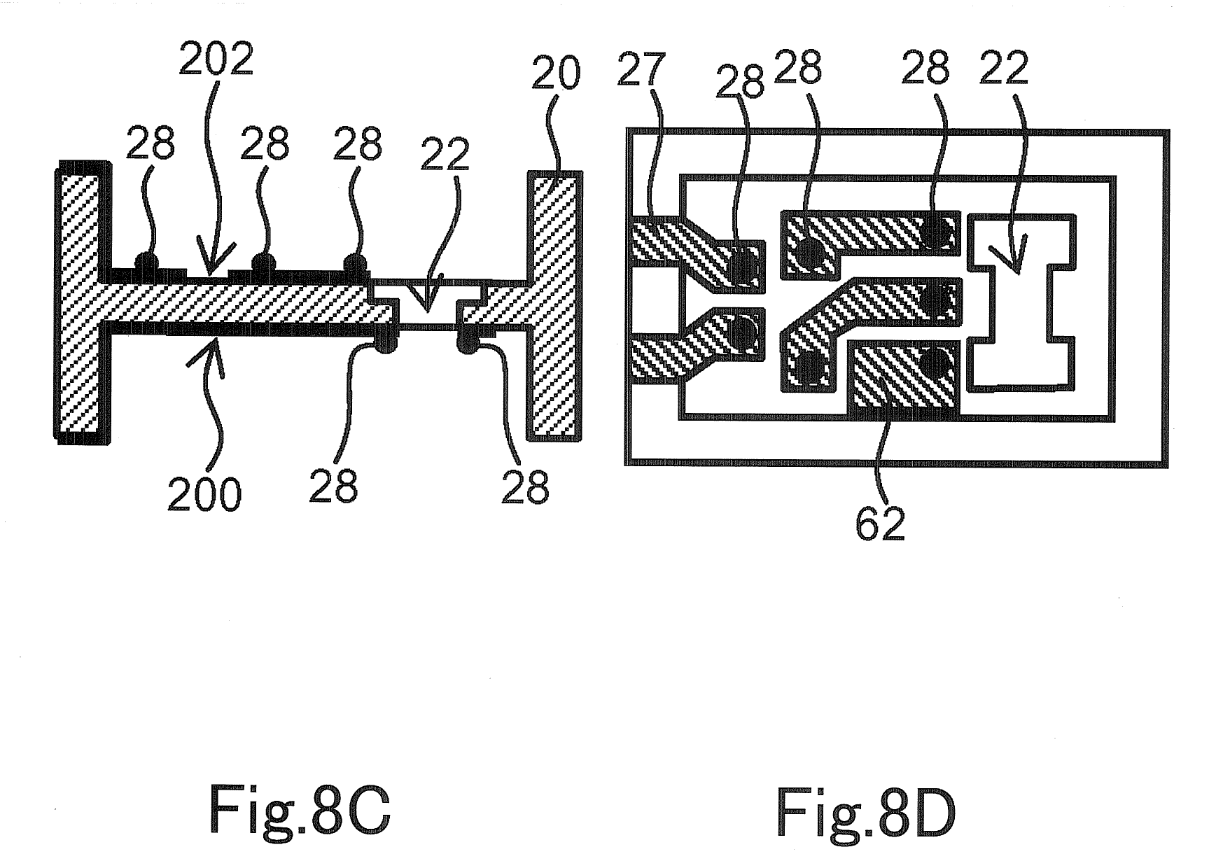

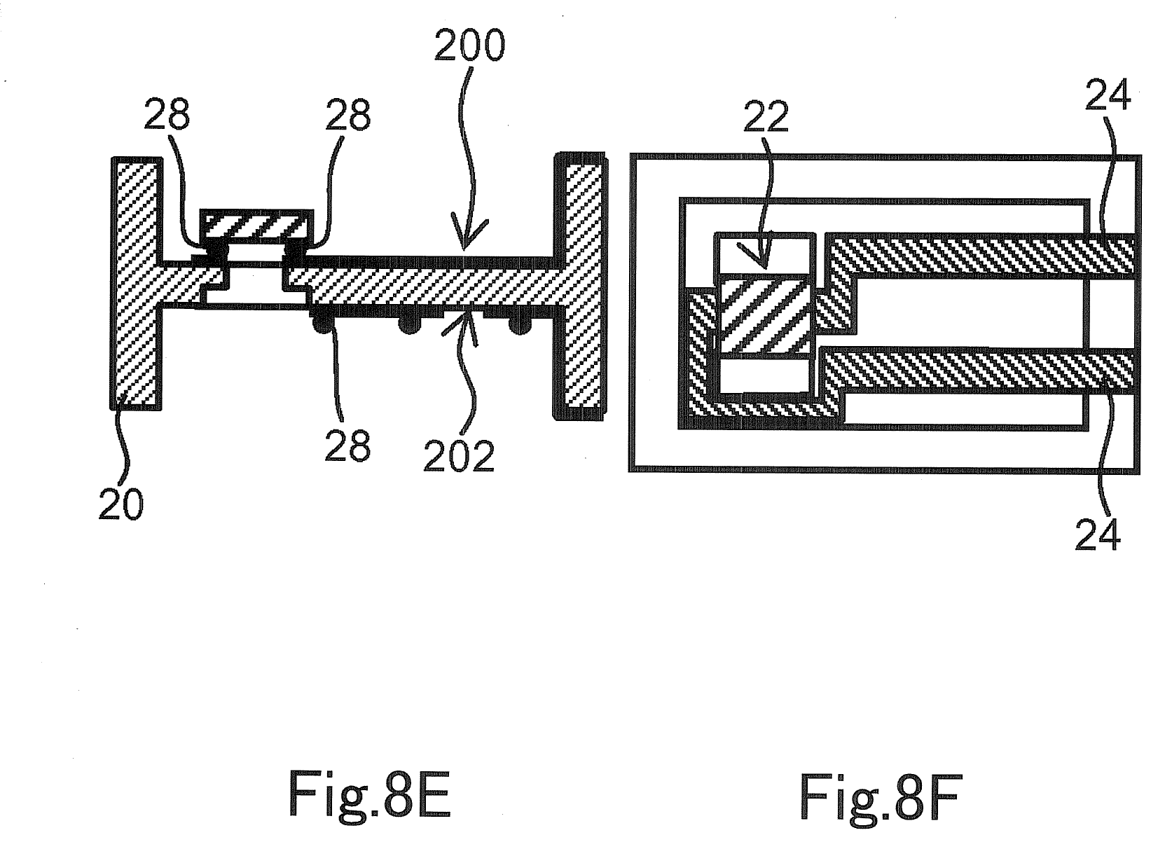

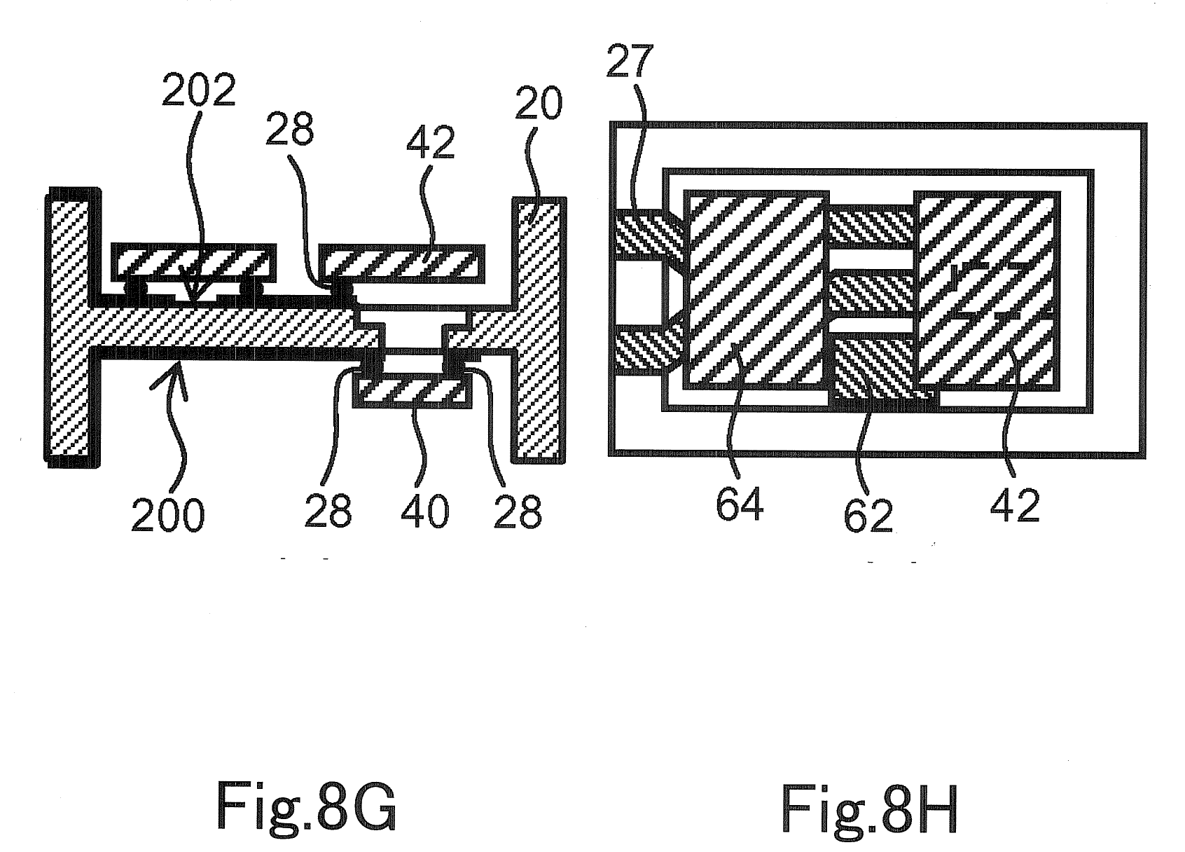

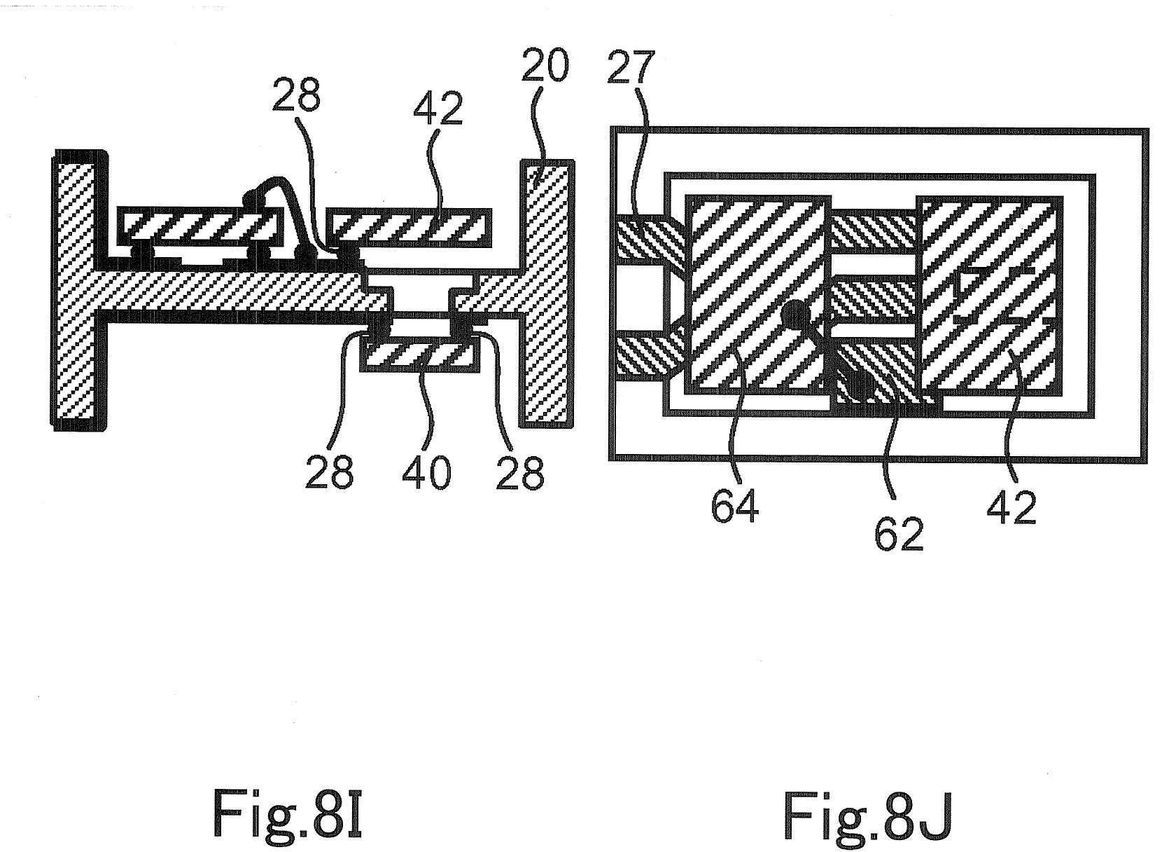

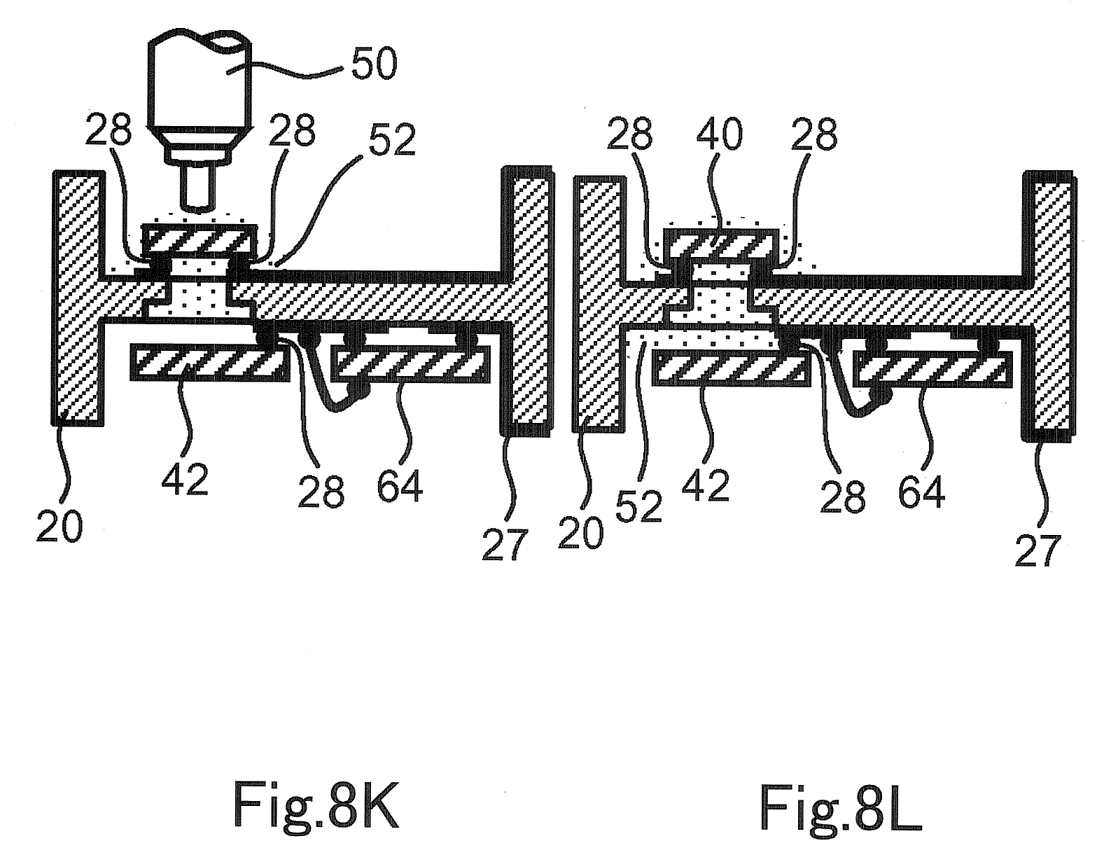

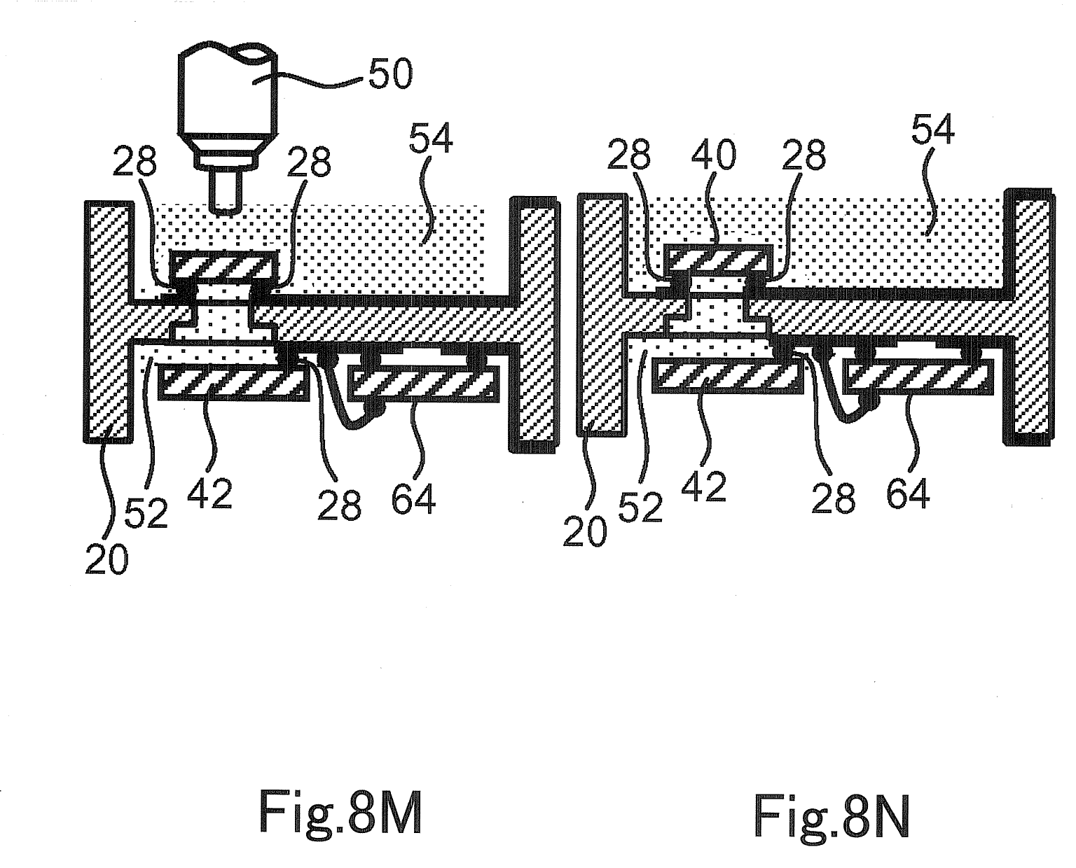

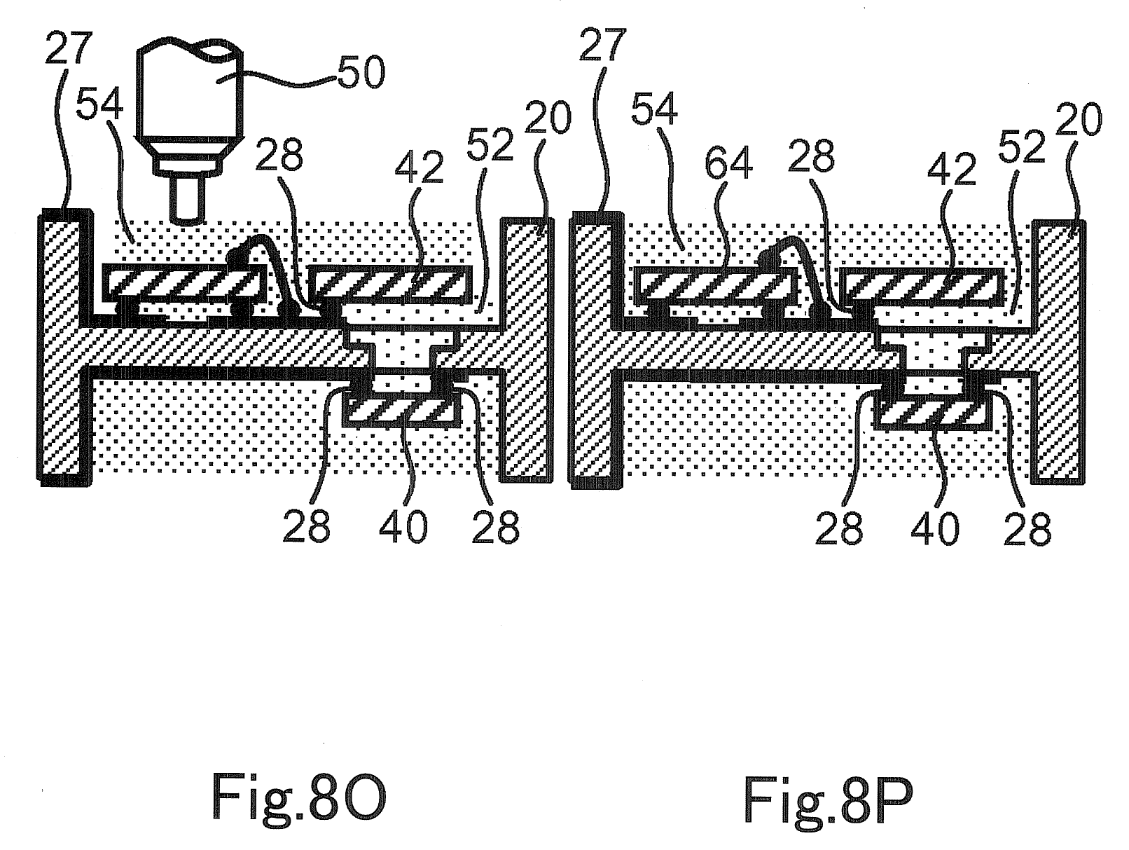

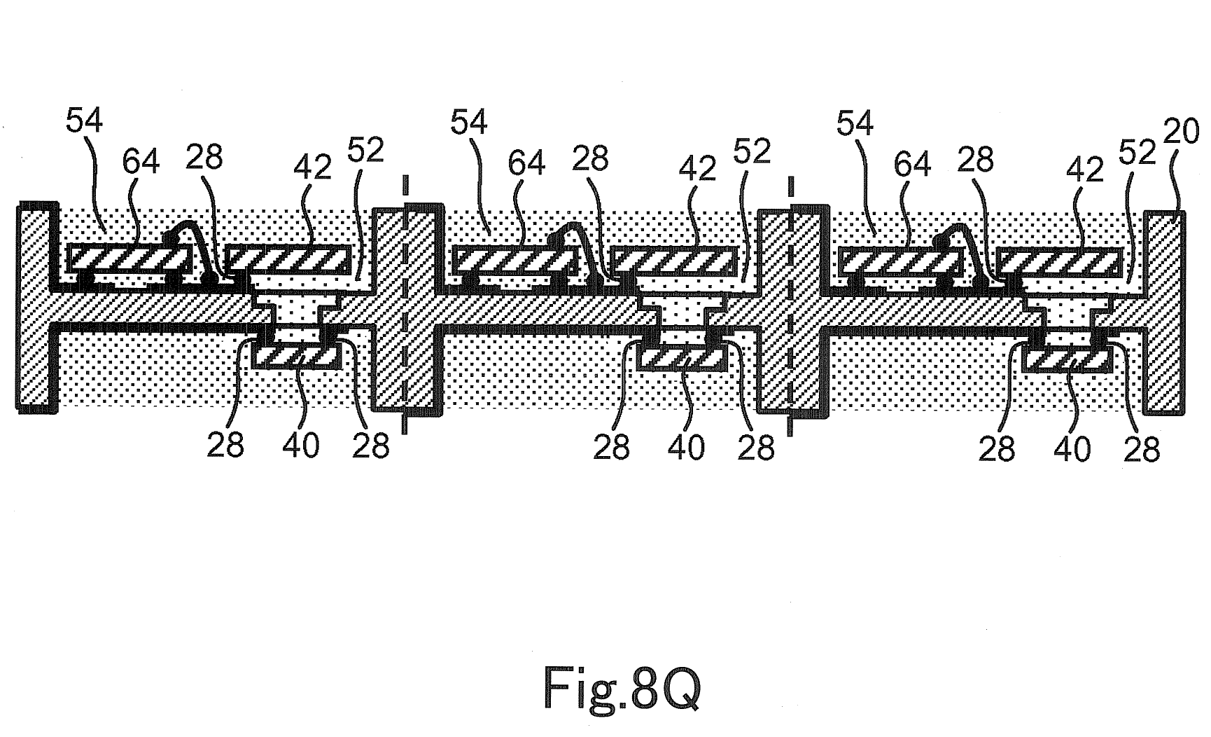

FIGS. 8A to 8Q are schematic views showing processes of manufacturing the present modification. Note that same reference numerals are given to the same components as those in FIGS. 7A to 7D, and detailed descriptions thereof will be omitted. FIGS. 8A and 8B show a process of forming bumps 28 for the light emitting element and bumps 28 for the MOSFET, and are respectively a schematic cross-sectional view and a schematic plan view.

On a first surface 200 of the supporting member 20, provided is a wiring layer 24 to be connected to two electrodes of a light emitting element 40, and two bumps 28 for the light emitting element are formed on a light emitting element bump region.

FIGS. 8C and 8D show a process of forming bumps 28 for light receiving element and bumps 28 for MOSFET, and are respectively a schematic cross-sectional view and a schematic bottom view. On a second surface 202 of the supporting member 20, provided are a wiring layer to be connected to two electrodes of a light receiving element 42 and a MOSFET backside connecting portion 62. On a light receiving element bump region 34, two bumps 28 are provided, and on the MOSFET backside connecting portion 62, one bump 28 is provided. In addition, on the same principal surface, provided is a wiring layer to be connected to four electrodes of the MOSFET 64, and on the MOSFET bump region, four bumps 28 for the MOSFET are 15 provided.

FIGS. 8E and 8F show a process of bonding the light emitting element 40 by flip chip bonding (FCB), and are respectively a schematic cross-sectional view and a schematic plan view.

FIGS. 8G and 8H show a process of bonding the light receiving element 42 and the MOSFET 64 by the FCB, and are respectively a schematic cross-sectional view and a schematic bottom view.

FIGS. 8I and 8 J show a process of connecting the backside of the MOSFET 64 and the MOSFET backside connecting portion 62 by a bonding wire 66, and are respectively a schematic cross-sectional view and a schematic plan view.

FIGS. 8K and 8L are schematic cross-sectional views showing processes of primarily sealing a portion between the light emitting element 40 and the light receiving element 42 by a translucent resin 52.

FIGS. 8M and 8N are schematic cross-sectional views showing processes of injecting a light shielding resin 54 into the inside of the supporting member 20 on the light emitting element 40 side. Furthermore, FIGS. 8O and 8P are schematic cross-sectional views showing processes of injecting the light shielding resin 54 into the inside of the supporting member 20 on the light receiving element 42 side. After being thermally cured, the light shielding resin becomes as shown in FIG. 8Q.

The processes of FIGS. 8A to 8P are performed in multiple chip processing performed on the connected supporting members. FIG. 8Q shows a connected state of the supporting members, and the supporting members are divided individually by cutting positions of broken lines.

Here, a comparative example will be described.

In the comparative example, light emitting elements are mounted with wire-bonding on multiple lead frames connected for processing. Similarly, light receiving elements are also mounted with wire-bonding on lead frames. Thereafter, the lead frames on the light emitting element side and the light receiving element side are stacked so that the light emitting element side and the light receiving element would face each other.

Next, the light emitting elements and the light receiving elements are primarily sealed with liquid translucent resin by use of its surface tension so as to be covered with the liquid translucent resin. In addition, the light emitting elements and the light receiving elements are secondarily sealed with a light shielding resin so that the translucent resin would be covered, and then the lead frames are folded. Lastly, the light emitting elements and the light receiving elements are divided into individual optical coupling devices

In this comparative example, in a case where the thickness between the lead frame and a package end surface, and the thickness between the translucent resin and the package end surface are thin, a package crack is likely to occur from the lead frame or the translucent resin by thermal stress. For this reason, a package needs to have a resin thickness of 0.5 mm or more on one side, and this necessity makes it difficult to provide a thinner and smaller package. For example, in the present comparative example, it was difficult to have a package thickness of 1.8 mm or less when an insulation thickness is included for securing insulation resistance. In addition, the shape of the translucent resin cannot be sufficiently controlled by the surface tension. Furthermore, the processes of forming an outer lead and a resin places a limitation on the number of chips manufactured at once, thereby leading to insufficient productivity.

In contrast, in the present embodiment, a supporting member for bonding a semiconductor element is firstly formed, and the semiconductor element is bonded thereon. Accordingly, thermal stress in an assembling process is reduced, and a material for suppressing the occurrence of a crack can be selected, making it possible to provide a thinner and smaller package. In addition, since the FCB is used, a thinner package can be easily provided. For example, it becomes possible to provide a package thickness of 1.4 mm or less while maintaining the insulation thickness. Furthermore, the wiring layers can be provided on the supporting member. This makes it unnecessary to perform the processes of exterior plating and of forming an outer lead become unnecessary, and also makes it easy to perform processing of multiple chips at once becomes easy. Consequently, the productivity of the manufacturing process is improved.

Embodiments of the invention have been described with reference to the examples. However, the invention is not limited thereto.

For example, the material of the LED chip is not limited to InGaAlP-based or GaN-based semiconductors, but may include various other Group 111-V compound semiconductors such as GaAlAs-based and InP-based semiconductors, or Group 11-VI compound semiconductors, or various other semiconductors.

Other embodiments of the present invention will be apparent to those skilled in the art from consideration of the specification and practice of the invention disclosed herein. It is intended that the specification and example embodiments be considered as exemplary only, with a true scope and spirit of the invention being indicated by the following.

What is claimed is:

1. An optical coupling device, comprising:
a supporting member which has a first surface, a second surface on the opposite side of the first surface, and an opening portion, and which is formed of an insulating material;
a first wiring layer provided on the first surface of the supporting member;
a second wiring layer provided on the second surface of the supporting member;
a light emitting element which is provided on the first surface, and which is connected to the first wiring layer, and at least one portion of which faces the opening portion;
a light receiving element which is provided on the second surface, and which is connected to the second wiring layer, and which faces the light emitting element through the opening portion;
a light shielding resin provided so as to cover the light emitting element, the light receiving element, and the first wiring layer and the second wiring layer.

2. An optical coupling device of claim 1, wherein the light emitting element and the first wiring layer are connected through a bump, and the light receiving element and the second wiring layer are connected through a bump.

3. An optical coupling device according to claim 1, wherein the opening portion of the supporting member is provided with a translucent resin.

4. The optical coupling device according to claim 1, further comprising,
a switching element which is provided on the second surface and is electrically connected to the second wiring layer; and
a third wiring layer provided on the second surface.

5. An optical coupling device, comprising:
a package having a supporting member which has a first surface, a second surface on the opposite side of the first surface, and an opening portion, and having a frame portion provided in a circumference of the supporting member;
a first wiring layer provided on the first surface of the supporting member;
a second wiring layer provided on the second surface of the supporting member;
a light emitting element which is provided on the first surface, and which is connected to the first wiring layer, and at least one portion of which faces the opening portion;
a light receiving element which is provided on the second surface, which is connected to the second wiring layer, and which faces the light emitting element through the opening portion; and
a light shielding resin provided so as to cover the light emitting element, the light receiving element, the first wiring layer and the second wiring layer.

6. An optical coupling device according to claim 5, wherein the light shielding resin is embedded in the frame portion.

7. An optical coupling device according to claim 5, wherein the first and second wiring layers have end portions extending to the frame portion to be exposed outside.
